(19) United States
(12) Patent Application Publication
(10) Pub. No.: US 2024/0306212 A1
(43) Pub. Date: Sep. 12, 2024

(54) COMMUNICATION METHOD AND COMMUNICATION APPARATUS

(71) Applicant: HUAWEI TECHNOLOGIES CO., LTD., Shenzhen (CN)

(72) Inventors: Xiaolu WANG, Hangzhou (CN); Hejia LUO, Hangzhou (CN); Jun WANG, Hangzhou (CN); Rong LI, Boulogne Billancourt (FR)

(21) Appl. No.: 18/660,964

(22) Filed: May 10, 2024

Related U.S. Application Data
(63) Continuation of application No. PCT/CN2022/124834, filed on Oct. 12, 2022.

(30) Foreign Application Priority Data
Nov. 12, 2021 (CN) 202111343098.7

(51) Int. Cl. H04W 74/0833; H04W 72/1268; H04W 74/08

(52) U.S. Cl. CPC H04W 74/0833; H04W 72/1268; H04W 74/0891

(57) ABSTRACT

A communication method and a communication apparatus. A terminal device obtains a first SSB. The terminal device sends a random access preamble corresponding to the first SSB. The random access preamble is carried at a first time domain position. The first time domain position is associated with a timing offset value. The timing offset value is determined based on a round-trip delay between the network device and a first position in an area covered by the network device.

### CROSS-REFERENCE TO RELATED APPLICATIONS

This application is a continuation of International Application No. PCT/CN2022/124834, filed on Oct. 12, 2022, which claims priority to Chinese Patent Application 202111343098.7, filed on Nov. 12, 2021. The disclosures of the aforementioned applications are hereby incorporated by reference in their entireties.

### BACKGROUND

A random access process is generally a process from sending, by a terminal device, a random access preamble (random access preamble, or preamble for short) to start to attempt to access a network device to establishing a basic signaling connection between the terminal device and the network device.

Currently, the network device broadcasts different synchronization signal/physical broadcast channel blocks (synchronization signal/physical broadcast channel blocks, SS/PBCH blocks, or SSBs) for different communication areas, and distinguish between the synchronization signal/physical broadcast channel blocks by using SSB indexes (indexes). Generally, a maximum of six bits corresponding to an SSB index are supported, in other words, a maximum value of a quantity of available SSB indexes is 64. After receiving an SSB, the terminal device sends a random access preamble based on an uplink resource corresponding to the SSB index. The network device determines, based on the received random access preamble and the corresponding uplink resource, an area in which the terminal device is located, and establish a connection to the terminal device.

To support wider service coverage, the network device is able to provide a network service for a larger communication area. Limited by the quantity of available SSB indexes, the network device is able to reuse a same SSB index in different communication areas.

However, after receiving the SSB, terminal devices in different communication areas sends random access preambles by using uplink resources corresponding to the same SSB index. Consequently, the network device cannot distinguish between communication areas in which the terminal devices are located, thereby affecting communication efficiency.

### SUMMARY

Embodiments described herein provide a communication method and a communication apparatus, so that a network device distinguishes between terminal devices in different communication areas based on time domain positions carrying random access preambles, to improve communication efficiency.

A first aspect of at least one embodiment provides a communication method. The method is performed by a terminal device, or the method is performed by some components (such as a processor, a chip, or a chip system) in a terminal device, or the method is implemented by a logical module or software that implements all or some functions of a terminal device. In the first aspect and at least one embodiment of the first aspect, an example in which the communication method is performed by the terminal device is used for description. In the method, the terminal device obtains a first SSB. The terminal device sends a random access preamble corresponding to the first SSB. The random access preamble is carried at a first time domain position. The first time domain position is associated with a timing offset value. The timing offset value is determined based on a round-trip delay between a network device and a first position in an area covered by the network device.

Based on the foregoing technical solution, after obtaining the first SSB, the terminal device sends, based on the first time domain position associated with the timing offset value, the random access preamble corresponding to the first SSB. The timing offset value is determined based on the round-trip delay between the first position in the area covered by the network device and the network device. In other words, timing offset values used by terminal devices in different communication areas is different. Therefore, after the terminal devices in the different communication areas receive SSBs, because the time domain position carrying the random access preamble sent by the terminal device is associated with the timing offset value, the network device distinguishes between the terminal devices in the different communication areas based on the time domain position carrying the random access preamble, to improve communication efficiency.

In at least one embodiment, the first time domain position includes one or more random access channel occasions (random access channel occasions, RACH occasions, or ROs), and the terminal device selects one of the one or more ROs as a time/frequency domain resource for carrying the random access preamble corresponding to the first SSB.

Optionally, the first time domain position including the one or more ROs is also referred to as an RO window (window). In other words, the terminal device selects one RO from the RO window as the time/frequency domain resource for carrying the random access preamble corresponding to the first SSB.

Inat least one embodiment of the first aspect, the first time domain position is obtained by offsetting a first moment based on the timing offset value, and the first moment is associated with the first SSB.

Optionally, this implementation is also expressed as that the first time domain position is located after a second moment obtained by offsetting the first moment by the timing offset value, and the first moment is associated with the first SSB.

Optionally, this implementation is also expressed as that the first time domain position is located after a second moment obtained after the timing offset value offsets the first moment, and the first moment is associated with the first SSB.

Based on the foregoing technical solution, the time domain position carrying the random access preamble corresponding to the first SSB is obtained based on the first moment associated with the first SSB. In other words, the time domain position is associated with the timing offset value and the first SSB. Because the timing offset values used by terminal devices in different communication areas is different, and the terminal devices in the different communication areas receives the first SSB at different moments, the network device further distinguishes between the terminal devices in the different communication areas based on the timing offset values and the first SSB.

In at least one embodiment of the first aspect, a start moment of the first time domain position is the second moment.

Based on the foregoing technical solution, the start moment of the first time domain position carrying the random access preamble corresponding to the first SSB is the second moment, and the second moment is obtained after the timing offset value offsets the first moment. In this way, the first time domain position carrying the random access preamble sent by the terminal device and the second moment are consecutive in time domain, to shorten as much time spent in a random access process.

In at least one embodiment of the first aspect, the first time domain position is located in one or more pieces of time information after the second moment, and the time information includes a frame or a half-frame.

Optionally, the time information includes a symbol, a slot, a subframe, or other time information.

Based on the foregoing technical solution, the first time domain position carrying the random access preamble corresponding to the first SSB is located in the one or more pieces of time information after the second moment, so that the terminal device determines the first time domain position based on the time information. A more flexible implementation is provided.

In at least one embodiment of the first aspect, the first time domain position is located in k association periodicity adjacent to the second moment, the association periodicity is a periodicity of an RO resource corresponding to an SSB set in which the first SSB is located, and k is an integer greater than 0.

Based on the foregoing technical solution, the first time domain position carrying the random access preamble corresponding to the first SSB is located in the k association periodicities adjacent to the second moment. The association periodicity is the periodicity of the RO resource corresponding to the SSB set in which the first SSB is located. In other words, in response to the corresponding RO resource being pre-configured in the SSB set, the terminal device sends the random access preamble on the pre-configured RO resource based on the first SSB, to improve a random access success rate.

In at least one embodiment of the first aspect, the first moment includes at least one of the following:
an end moment of a time domain position of the first SSB;
a start moment of a time domain position of the first SSB;
an end moment of a slot in which a time domain position of the first SSB is located;
a start moment of a slot in which a time domain position of the first SSB is located;
an end moment of a time domain position of a second SSB, where the second SSB and the first SSB are located in a same SSB set, and an index of the second SSB is different from an index of the first SSB;
a start moment of a time domain position of a second SSB;
an end moment of a slot in which a time domain position of a second SSB is located; or
a start moment of a slot in which a time domain position of a second SSB is located.

Based on the foregoing technical solution, the first time domain position carrying the random access preamble is obtained by offsetting the first moment based on the timing offset value, and the first moment is associated with the first SSB. The terminal device determines the first moment based on one or more of the foregoing manners.

In at least one embodiment of the first aspect, the method further includes: The terminal device obtains the timing offset value.

Based on the foregoing technical solution, the terminal device receives the timing offset value sent by the network device, so that the timing offset value used by the terminal device is determined between the network device and the terminal device and the random access preamble is obtained, to improve the random access success rate.

Optionally, the terminal device obtains the timing offset value via an indication of a relay node between the terminal device and the network device.

Optionally, the network device that sends the timing offset value to the terminal device and the network device that sends the first SSB to the terminal device is a same network device, or is different network devices. This is not limited herein.

Optionally, the timing offset value is pre-configured in the terminal device.

In at least one embodiment of the first aspect, that the terminal device sends a random access preamble corresponding to the first SSB includes: The terminal device sends, based on first information, the random access preamble corresponding to the first SSB, where the first information includes at least one of the following:
a time length of the first time domain position;
a quantity of random access channel occasion RO resources included in the first time domain position, where the RO resource is used to carry the random access preamble: or
a quantity of SSBs corresponding to the first time domain position.

Based on the foregoing technical solution, the first time domain position includes one or more ROs. The terminal device determines, based on the first information, the first time domain position carrying the random access preamble. The first information includes at least one of the following: the time length of the first time domain position, the quantity of ROs included in the first time domain position, or the quantity of SSBs corresponding to the first time domain position, so that the terminal device determines the first time domain position based on the first information.

In at least one embodiment of the first aspect, the method further includes: The terminal device obtains the first information.

Based on the foregoing technical solution, the terminal device receives the first information sent by the network device, so that the first information used by the terminal device is determined between the network device and the terminal device and the random access preamble is obtained, to improve the random access success rate.

Optionally, the terminal device obtains the first information via an indication of a relay node between the terminal device and the network device.

Optionally, the network device that sends the first information to the terminal device and the network device that sends the first SSB to the terminal device is a same network device, or is different network devices. This is not limited herein.

Optionally, the first information is pre-configured in the terminal device.

In at least one embodiment of the first aspect, the first time domain position is associated with the timing offset value and second information, and the second information includes at least one of the following:
n first preset values, where n indicates an index position of the first SSB in the SSB set, and n is a natural number;
processing delay information;
positioning error information: or
ephemeris error information.

Based on the foregoing technical solution, the terminal device determines, based on the second information, the first time domain position carrying the random access preamble. In response to the second information including the n first preset values, the first time domain position is not limited by an SSB interval. In response to the second information including at least one of the processing delay information, the positioning error information, and the ephemeris error information, accurate processing duration is reserved for the terminal device, to improve the random access success rate.

In at least one embodiment of the first aspect, a value of the timing offset value is related to a value of an offset Koffset value, where the Koffset value is used to determine a scheduling interval of a physical uplink shared channel (physical uplink shared channel, PUSCH) signal.

Optionally, the value of the timing offset value is the same as the value of the offset Koffset value, or the value of the timing offset value and the value of the offset Koffset value meet a specific mathematical relationship.

Based on the foregoing technical solution, the value of the timing offset value is related to the value of the offset Koffset value. In other words, the terminal device determines the value of the timing offset value based on the value of the offset Koffset value, so that a process of determining the timing offset value is based on related configuration information of the offset Koffset value, to reduce signaling overheads.

In at least one embodiment of the first aspect, the first position includes any one of the following: a position that is within cell coverage and that is farthest from the network device, a position that is within beam coverage and that is farthest from the network device, and a position of the terminal device.

Based on the foregoing technical solution, the timing offset value is determined based on the round-trip delay between the first position in the area covered by the network device and the network device. The network device configures a common timing offset value for a plurality of terminal devices in the coverage area. In other words, the first position is the position that is within the cell coverage and that is farthest from the network device, or the position that is within the beam coverage and that is farthest from the network device. This helps reduce the signaling overheads. Alternatively, the network device separately configures a timing offset value for the terminal device in the coverage area. In other words, the first position is the position of the terminal device. This helps improve accuracy.

A second aspect of at least one embodiment provides a communication method. The method is performed by a network device, or the method is performed by some components (such as a processor, a chip, or a chip system) in a network device, or the method is implemented by a logical module or software that implements all or some functions of a network device. In the first aspect and at least one embodiment of the first aspect, an example in which the communication method is performed by the network device is used for description. In the method, the network device sends a first SSB. The network device obtains a random access preamble corresponding to the first SSB. The random access preamble is carried at a first time domain position. The first time domain position is associated with a timing offset value. The timing offset value is determined based on a round-trip delay between the network device and a first position in an area covered by the network device.

Based on the foregoing technical solution, after the network device sends the first SSB, a terminal device sends, based on the first time domain position associated with the timing offset value, the random access preamble corresponding to the first SSB, and the network device receives the random access preamble. The timing offset value is determined based on the round-trip delay between the first position in the area covered by the network device and the network device. In other words, timing offset values used by terminal devices in different communication areas is different. Therefore, after the terminal devices in the different communication areas receive SSBs, because the time domain position carrying the random access preamble sent by the terminal device is associated with the timing offset value, the network device distinguishes between the terminal devices in the different communication areas based on the time domain position carrying the random access preamble, to improve communication efficiency.

In at least one embodiment of the second aspect, the first time domain position is obtained by offsetting a first moment based on the timing offset value, and the first moment is associated with the first SSB.

Optionally, this implementation is also expressed as that the first time domain position is located after a second moment obtained by offsetting the first moment by the timing offset value, and the first moment is associated with the first SSB.

Optionally, this implementation is also expressed as that the first time domain position is located after a second moment obtained after the timing offset value offsets the first moment, and the first moment is associated with the first SSB.

Based on the foregoing technical solution, the time domain position carrying the random access preamble corresponding to the first SSB is obtained based on the first moment associated with the first SSB. In other words, the time domain position is associated with the timing offset value and the first SSB. Because the timing offset values used by terminal devices in different communication areas is different, and the terminal devices in the different communication areas receives the first SSB at different moments, the network device further distinguishes between the terminal devices in the different communication areas based on the timing offset values and the first SSB.

In at least one embodiment of the second aspect, a start moment of the first time domain position is the second moment.

Based on the foregoing technical solution, the start moment of the first time domain position carrying the random access preamble corresponding to the first SSB is the second moment, and the second moment is obtained after the timing offset value offsets the first moment. In this way, the first time domain position carrying the random access preamble sent by the terminal device and the second moment are consecutive in time domain, to shorten as much time spent in a random access process.

In at least one embodiment of the second aspect, the first time domain position is located in one or more pieces of time information after the second moment, and the time information includes a frame or a half-frame.

Optionally, the time information includes a symbol, a slot, a subframe, or other time information.

Based on the foregoing technical solution, the first time domain position carrying the random access preamble corresponding to the first SSB is located in the one or more pieces of time information after the second moment, so that the terminal device determines the first time domain position based on the time information. A more flexible implementation is provided.

In at least one embodiment of the second aspect, the first time domain position is located in k association periodicities adjacent to the second moment, the association periodicity is a periodicity of an RO resource corresponding to an SSB set in which the first SSB is located, and k is an integer greater than 0.

Based on the foregoing technical solution, the first time domain position carrying the random access preamble corresponding to the first SSB is located in the k association periodicities adjacent to the second moment. The association periodicity is the periodicity of the RO resource corresponding to the SSB set in which the first SSB is located. In other words, in response to the corresponding RO resource being pre-configured in the SSB set, the terminal device sends the random access preamble on the pre-configured RO resource based on the first SSB, to improve a random access success rate.

In at least one embodiment of the second aspect, the first moment includes at least one of the following:
an end moment of a time domain position of the first SSB;
a start moment of a time domain position of the first SSB;
an end moment of a slot in which a time domain position of the first SSB is located;
a start moment of a slot in which a time domain position of the first SSB is located;
an end moment of a time domain position of a second SSB, where the second SSB and the first SSB are located in a same SSB set, and an index of the second SSB is different from an index of the first SSB;
a start moment of a time domain position of a second SSB;
an end moment of a slot in which a time domain position of a second SSB is located; or
a start moment of a slot in which a time domain position of a second SSB is located.

Based on the foregoing technical solution, the first time domain position carrying the random access preamble is obtained by offsetting the first moment based on the timing offset value, and the first moment is associated with the first SSB. The terminal device determines the first moment based on one or more of the foregoing manners.

In at least one embodiment of the second aspect, the method further includes: The network device sends the timing offset value.

Based on the foregoing technical solution, the terminal device receives the timing offset value sent by the network device, so that the timing offset value used by the terminal device is determined between the network device and the terminal device and the random access preamble is obtained, to improve the random access success rate.

In at least one embodiment of the second aspect, that the network device obtains a random access preamble corresponding to the first SSB includes: The network device obtains, based on first information, the random access preamble corresponding to the first SSB, where the first information indicates at least one of the following:
a time length of the first time domain position;
a quantity of random access channel occasion RO resources included in the first time domain position, where the RO resource is used to carry the random access preamble: or
a quantity of SSBs corresponding to the first time domain position.

Based on the foregoing technical solution, the first time domain position includes one or more ROs. The network device determines, based on the first information, the first time domain position carrying the random access preamble. The first information includes at least one of the following: the time length of the first time domain position, the quantity of ROs included in the first time domain position, or the quantity of SSBs corresponding to the first time domain position, so that the network device determines the first time domain position based on the first information.

In at least one embodiment of the second aspect, the method further includes: The network device sends the first information.

Based on the foregoing technical solution, the terminal device receives the first information sent by the network device, so that the first information used by the terminal device is determined between the network device and the terminal device and the random access preamble is obtained, to improve the random access success rate.

In at least one embodiment of the second aspect, the first time domain position is associated with the timing offset value and second information, and the second information includes at least one of the following:
n first preset values, where n indicates an index position of the first SSB in the SSB set, and n is a natural number;
processing delay information;
positioning error information: or
ephemeris error information.

Based on the foregoing technical solution, the terminal device determines, based on the second information, the first time domain position carrying the random access preamble. In response to the second information including the n first preset values, the first time domain position is not limited by an SSB interval. In response to the second information including at least one of the processing delay information, the positioning error information, and the ephemeris error information, accurate processing duration is reserved for the terminal device, to improve the random access success rate.

In at least one embodiment of the second aspect, a value of the timing offset value is related to a value of an offset Koffset value, where the Koffset value is used to determine a scheduling interval of a physical uplink shared channel PUSCH signal.

Optionally, the value of the timing offset value is the same as the value of the offset Koffset value, or the value of the timing offset value and the value of the offset Koffset value meet a specific mathematical relationship.

Based on the foregoing technical solution, the value of the timing offset value is related to the value of the offset Koffset value. In other words, the terminal device determines the value of the timing offset value based on the value of the offset Koffset value, so that a process of determining the timing offset value is based on related configuration information of the offset Koffset value, to reduce signaling overheads.

In at least one embodiment of the second aspect, the first position includes any one of the following: a position that is within cell coverage and that is farthest from the network device, a position that is within beam coverage and that is farthest from the network device, and a position of the terminal device.

Based on the foregoing technical solution, the timing offset value is determined based on the round-trip delay between the first position in the area covered by the network device and the network device. The network device configures a common timing offset value for a plurality of terminal devices in the coverage area. In other words, the first position is the position that is within the cell coverage and that is farthest from the network device, or the position that is within the beam coverage and that is farthest from the network device. This helps reduce the signaling overheads. Alternatively, the network device separately configures a timing offset value for the terminal device in the coverage area. In other words, the first position is the position of the terminal device. This helps improve accuracy.

A third aspect of at least one embodiment provides a communication apparatus. The apparatus implements the method according to any one of the first aspect or the implementations of the first aspect. The apparatus includes a corresponding unit or module configured to perform the foregoing method. The unit or module included in the apparatus is implemented by software and/or hardware. For example, the apparatus is a terminal device, or the apparatus is a component (for example, a processor, a chip, or a chip system) in a terminal device, or the apparatus is a logical module or software that implements all or some functions of a terminal device.

The communication apparatus includes a processing unit and a transceiver unit.

The transceiver unit is configured to obtain a first synchronization signal block SSB.

The transceiver unit is configured to send a random access preamble corresponding to the first SSB, where the random access preamble is carried at a first time domain position, the first time domain position is associated with a timing offset value, and the timing offset value is determined based on a round-trip delay between a network device and a first position in an area covered by the network device.

In at least one embodiment of the third aspect, the first time domain position is obtained by offsetting a first moment based on the timing offset value, and the first moment is associated with the first SSB.

In at least one embodiment of the third aspect, the first time domain position is located after a second moment obtained by offsetting the first moment by the timing offset value.

In at least one embodiment of the third aspect, the first time domain position is located after a second moment obtained after the timing offset value offsets the first moment, and the first moment is associated with the first SSB.

In at least one embodiment of the third aspect, a start moment of the first time domain position is the second moment.

In at least one embodiment of the third aspect, the first time domain position is located in one or more pieces of time information after the second moment, and the time information includes a frame or a half-frame.

In at least one embodiment of the third aspect, the first time domain position is located in k association periodicities adjacent to the second moment, the association periodicity is a periodicity of an RO resource corresponding to an SSB set in which the first SSB is located, and k is an integer greater than 0.

In at least one embodiment of the third aspect, the first moment includes at least one of the following:
an end moment of a time domain position of the first SSB;
a start moment of a time domain position of the first SSB;
an end moment of a slot in which a time domain position of the first SSB is located;
a start moment of a slot in which a time domain position of the first SSB is located;
an end moment of a time domain position of a second SSB, where the second SSB and the first SSB are located in a same SSB set, and an index of the second SSB is different from an index of the first SSB;
a start moment of a time domain position of a second SSB;
an end moment of a slot in which a time domain position of a second SSB is located; or
a start moment of a slot in which a time domain position of a second SSB is located.

In at least one embodiment of the third aspect, the transceiver unit is further configured to obtain the timing offset value.

In at least one embodiment of the third aspect, that the transceiver unit is configured to send a random access preamble corresponding to the first SSB includes:
the transceiver unit is configured to send, based on first information, the random access preamble corresponding to the first SSB, where the first information includes at least one of the following;
a time length of the first time domain position;
a quantity of random access channel occasion RO resources included in the first time domain position, where the RO resource is used to carry the random access preamble: or
a quantity of SSBs corresponding to the first time domain position.

In at least one embodiment of the third aspect,
the transceiver unit is further configured to obtain the first information.

In at least one embodiment of the third aspect, the first time domain position is associated with the timing offset value and second information, and the second information includes at least one of the following:
n first preset values, where n indicates an index position of the first SSB in the SSB set, and n is a natural number;
processing delay information;
positioning error information: or
ephemeris error information.

In at least one embodiment of the third aspect, a value of the timing offset value is related to a value of an offset Koffset value, where the Koffset value is used to determine a scheduling interval of a physical uplink shared channel PUSCH signal.

In at least one embodiment of the third aspect, the first position includes any one of the following:
a position that is within cell coverage and that is farthest from the network device, a position that is within beam coverage and that is farthest from the network device, and a position of the terminal device.

In the third aspect of at least one embodiment, composition modules of the communication apparatus are further configured to perform the steps performed in the implementations of the first aspect. For details, refer to the first aspect. Details are not described herein again.

A fourth aspect of at least one embodiment provides a communication apparatus. The apparatus implements the method according to any one of the second aspect or the implementations of the second aspect. The apparatus includes a corresponding unit or module configured to perform the foregoing method. The unit or module included in the apparatus is implemented by software and/or hardware. For example, the apparatus is a network device, or the apparatus is a component (for example, a processor, a chip, or a chip system) in a network device, or the apparatus is a logical module or software that implements all or some functions of a network device.

The communication apparatus includes a transceiver unit and a processing unit.

The transceiver unit is configured to send a first synchronization signal block SSB.

The transceiver unit is configured to obtain a random access preamble corresponding to the first SSB, where the random access preamble is carried at a first time domain position, the first time domain position is associated with a timing offset value, and the timing offset value is determined based on a round-trip delay between the network device and a first position in an area covered by the network device.

In at least one embodiment of the fourth aspect, the first time domain position is obtained by offsetting a first moment based on the timing offset value, and the first moment is associated with the first SSB.

In at least one embodiment of the fourth aspect, the first time domain position is located after a second moment obtained by offsetting the first moment by the timing offset value.

In at least one embodiment of the fourth aspect, the first time domain position is located after a second moment obtained after the timing offset value offsets the first moment, and the first moment is associated with the first SSB.

In at least one embodiment of the fourth aspect, a start moment of the first time domain position is the second moment.

In at least one embodiment of the fourth aspect, the first time domain position is located in one or more pieces of time information after the second moment, and the time information includes a frame or a half-frame.

In at least one embodiment of the fourth aspect, the first time domain position is located in k association periodicities adjacent to the second moment, the association periodicity is a periodicity of an RO resource corresponding to an SSB set in which the first SSB is located, and k is an integer greater than 0.

In at least one embodiment of the fourth aspect, the first moment includes at least one of the following:
an end moment of a time domain position of the first SSB;
a start moment of a time domain position of the first SSB;
an end moment of a slot in which a time domain position of the first SSB is located;
a start moment of a slot in which a time domain position of the first SSB is located;
an end moment of a time domain position of a second SSB, where the second SSB and the first SSB are located in a same SSB set, and an index of the second SSB is different from an index of the first SSB;
a start moment of a time domain position of a second SSB;
an end moment of a slot in which a time domain position of a second SSB is located; or
a start moment of a slot in which a time domain position of a second SSB is located.

In at least one embodiment of the fourth aspect, the transceiver unit is further configured to send the timing offset value.

In at least one embodiment of the fourth aspect, that the transceiver unit is configured to obtain a random access preamble corresponding to the first SSB includes:

the transceiver unit is configured to obtain, based on first information, the random access preamble corresponding to the first SSB, where the first information indicates at least one of the following:
a time length of the first time domain position;
a quantity of random access channel occasion RO resources included in the first time domain position, where the RO resource is used to carry the random access preamble: or
a quantity of SSBs corresponding to the first time domain position.

In at least one embodiment of the fourth aspect, the transceiver unit is further configured to send the first information.

In at least one embodiment of the fourth aspect, the first time domain position is associated with the timing offset value and second information, and the second information includes at least one of the following:
n first preset values, where n indicates an index position of the first SSB in the SSB set, and n is a natural number;
processing delay information;
positioning error information: or
ephemeris error information.

In at least one embodiment of the fourth aspect, a value of the timing offset value is related to a value of an offset Koffset value, where the Koffset value is used to determine a scheduling interval of a physical uplink shared channel PUSCH signal.

In at least one embodiment of the fourth aspect, the first position includes any one of the following:
a position that is within cell coverage and that is farthest from the network device, a position that is within beam coverage and that is farthest from the network device, and a position of the terminal device.

In the fourth aspect of at least one embodiment, composition modules of the communication apparatus are further configured to perform the steps performed in the implementations of the second aspect. For details, refer to the second aspect. Details are not described herein again.

A fifth aspect of at least one embodiment provides a communication apparatus, including at least one processor, where the at least one processor is coupled to a memory.

The memory is configured to store a program or instructions.

The at least one processor is configured to execute the program or the instructions, to enable the apparatus to implement the method according to any one of the first aspect or the implementations of the first aspect, or enable the apparatus to implement the method according to any one of the second aspect or the implementations of the second aspect.

A sixth aspect of at least one embodiment provides a communication apparatus, including at least one logic circuit and an input/output interface.

The input/output interface is configured to output a target signal.

The logic circuit is configured to perform the method according to any one of the first aspect or the implementations of the first aspect.

A seventh aspect of at least one embodiment provides a communication apparatus, including at least one logic circuit and an input/output interface.

The input/output interface is configured to input a target signal.

The logic circuit is configured to perform the method according to any one of the second aspect or the implementations of the second aspect.

An eighth aspect of at least one embodiment provides a computer-readable storage medium storing one or more computer-executable instructions. In response to the computer-executable instructions being executed by a processor, the processor performs the method according to any one of the first aspect or the implementations of the first aspect.

A ninth aspect of at least one embodiment provides a computer-readable storage medium storing one or more computer-executable instructions. In response to the computer-executable instructions being executed by a processor, the processor performs the method according to any one of the second aspect or the implementations of the second aspect.

A tenth aspect of at least one embodiment provides a computer program product (or referred to as a computer program) storing one or more computers. In response to the computer program product being executed by a processor, the processor performs the method according to any one of the first aspect or the implementations of the first aspect.

An eleventh aspect of at least one embodiment provides a computer program product storing one or more computers. In response to the computer program product being executed by a processor, the processor performs the method according to any one of the second aspect or the implementations of the second aspect.

A twelfth aspect of at least one embodiment provides a chip system. The chip system includes at least one processor, configured to support a communication apparatus in implementing the function in any one of the first aspect or the implementations of the first aspect.

In at least one embodiment, the chip system further includes a memory. The memory is configured to store program instructions and data that are used for the communication apparatus. The chip system includes a chip, or includes a chip and another discrete component. Optionally, the chip system further includes an interface circuit, and the interface circuit provides program instructions and/or data for the at least one processor.

A thirteenth aspect of at least one embodiment provides a chip system. The chip system includes at least one processor, configured to support a communication apparatus in implementing the function in any one of the second aspect or the implementations of the second aspect.

In a possible design, the chip system further includes a memory. The memory is configured to store program instructions and data that are used for the second communication apparatus. The chip system includes a chip, or includes a chip and another discrete component. Optionally, the chip system further includes an interface circuit, and the interface circuit provides program instructions and/or data for the at least one processor.

A fourteenth aspect of at least one embodiment provides a communication system. The communication system includes the communication apparatus according to the third aspect and the communication apparatus according to the fourth aspect, and/or the communication system includes the communication apparatus according to the fifth aspect, and/or the communication system includes the communication apparatus according to the sixth aspect and the communication apparatus according to the seventh aspect.

For the technical effects brought by any one of the design manners of the third aspect to the fourteenth aspect, refer to the technical effects brought by different design manners of the first aspect or the second aspect. Details are not described herein again.

From the foregoing technical solutions, after the terminal devices in the different communication areas receive SSBs, because the time domain position carrying the random access preamble sent by the terminal device is associated with the timing offset value, the network device distinguishes between the terminal devices in the different communication areas based on the time domain position carrying the random access preamble, to improve the communication efficiency.

### BRIEF DESCRIPTION OF DRAWINGS

FIG. 1a is a schematic diagram of a communication scenario according to at least one embodiment:

FIG. 1b is another schematic diagram of a communication scenario according to at least one embodiment;

FIG. 2 is another schematic diagram of a communication scenario according to at least one embodiment:

FIG. 3 is another schematic diagram of a communication scenario according to at least one embodiment:

FIG. 4 is another schematic diagram of a communication scenario according to at least one embodiment:

FIG. 5 is a schematic diagram of a communication method according to at least one embodiment:

FIG. 6 is another schematic diagram of a communication method according to at least one embodiment;

FIG. 7 is another schematic diagram of a communication method according to at least one embodiment:

FIG. 8 is another schematic diagram of a communication method according to at least one embodiment:

FIG. 9 is another schematic diagram of a communication method according to at least one embodiment:

FIG. 10 is another schematic diagram of a communication method according to at least one embodiment:

FIG. 11 is another schematic diagram of a communication method according to at least one embodiment:

FIG. 12 is another schematic diagram of a communication method according to at least one embodiment:

FIG. 13 is another schematic diagram of a communication method according to at least one embodiment:

FIG. 14 is a schematic diagram of a communication apparatus according to at least one embodiment:

FIG. 15 is another schematic diagram of a communication apparatus according to at least one embodiment:

FIG. 16 is another schematic diagram of a communication apparatus according to at least one embodiment; and

FIG. 17 is another schematic diagram of a communication apparatus according to at least one embodiment.

### DESCRIPTION OF EMBODIMENTS

The following describes the technical solutions in at least one embodiment with reference to the accompanying drawings. All other embodiments obtained by a person of ordinary skill in the art based on at least one embodiment without creative efforts shall fall within the protection scope embodiments described herein.

First, some terms in at least one embodiment are explained and described, to facilitate understanding of a person skilled in the art.

(1) A terminal device is a wireless terminal device that receives scheduling and indication information of a network device. The wireless terminal device is a device that provides voice and/or data connectivity for a user, a handheld device with a wireless connection function, or another processing device connected to a wireless modem.

The terminal device communicates with one or more core networks or the internet through a radio access network (radio access network, RAN). The terminal device is a mobile terminal device, for example, a mobile telephone (or referred to as a “cellular” phone or a mobile phone (mobile phone)), a computer, and a data card. For example, the terminal device is a portable, pocket-sized, handheld, computer built-in, or vehicle-mounted mobile apparatus that exchanges a voice and/or data with the radio access network. For example, the terminal device is a device, for example, a personal communication service (personal communication service, PCS) phone, a cordless phone, a session initiation protocol (SIP) phone, a wireless local loop (wireless local loop, WLL) station, a personal digital assistant (personal digital assistant, PDA), a tablet computer (Pad), or a computer having a wireless transceiver function. The wireless terminal device is also referred to as a system, a subscriber unit (subscriber unit), a subscriber station (subscriber station), a mobile station (mobile station), a mobile station (mobile station, MS), a remote station (remote station), an access point (access point, AP), a remote terminal device (remote terminal), an access terminal device (access terminal), a user terminal device (user terminal), a user agent (user agent), a subscriber station (subscriber station, SS), customer premises equipment (customer premises equipment, CPE), a terminal (terminal), user equipment (user equipment, UE), or a mobile terminal (mobile terminal, MT). The terminal device alternatively is a wearable device and a terminal device in a next generation communication system, for example, a terminal device in a 5G communication system or a terminal device in a future evolved public land mobile network (public land mobile network, PLMN).

(2) A network device is a device in a wireless network, for example, is a radio access network (radio access network, RAN) node (or device), or is referred to as a base station, through which a terminal device accesses the wireless network. Currently, some examples of the RAN device are: a next-generation NodeB (next-generation NodeB, gNodeB) in a 5G communication system, a transmission reception point (transmission reception point, TRP), an evolved NodeB (evolved NodeB, eNB), a radio network controller (radio network controller, RNC), a NodeB (NodeB, NB), a base station controller (base station controller, BSC), a base transceiver station (base transceiver station, BTS), a home base station (for example, a home evolved NodeB or a home NodeB, HNB), a baseband unit (baseband unit, BBU), a wireless fidelity (wireless fidelity, Wi-Fi) access point (access point, AP), or the like. In addition, in a network structure, the network device includes a central unit (central unit, CU) node, a distributed unit (distributed unit, DU) node, or a RAN device including a CU node and a DU node.

The network device sends configuration information (for example, carried in a scheduling message and/or an indication message) to the terminal device. The terminal device further performs network configuration based on the configuration information, so that the network configurations of the network device and the terminal device are aligned. Alternatively, through a network configuration preset in the network device and a network configuration preset in the terminal device, the network configurations of the network device and the terminal device are aligned. Specifically, “alignment” means that in response to there being an interaction message between the network device and the terminal device, the network device and the terminal device have a consistent understanding of a carrier frequency for sending and receiving the interaction message, determining of a type of the interaction message, a meaning of field information carried in the interaction message, or another configuration of the interaction message.

In addition, in another case, the network device is another apparatus providing a wireless communication function for the terminal device. A specific technology and a specific device form that are used by the network device are not limited in at least one embodiment. For ease of description, this is not limited in at least one embodiment.

The network device further includes a core network device. The core network device includes, for example, an access and mobility management function (access and mobility management function, AMF), a user plane function (user plane function, UPF), or a session management function (session management function, SMF).

In at least one embodiment, an apparatus configured to implement a function of the network device is a network device, or is an apparatus, for example, a chip system, that supports the network device in implementing the function. The apparatus is installed in the network device. In the technical solutions provided in at least one embodiment, an example in which the apparatus configured to implement the function of the network device is the network device is used for describing the technical solutions provided in at least one embodiment.

(3) Configuration and pre-configuration: In at least one embodiment, both the configuration and the pre-configuration are used. The configuration means that a network device sends configuration information of some parameters or parameter values to a terminal device by using a message or signaling, so that the terminal device determines a communication parameter or a transmission resource based on the values or the information. Similar to the configuration, the pre-configuration is parameter information or a parameter value negotiated by the network device and the terminal device in advance, or is parameter information or a parameter value that is used by the network device or the terminal device and that is specified in a standard protocol, or is parameter information or a parameter value that is pre-stored in the network device or the terminal device. This is not limited in at least one embodiment.

Further, these values and parameters is changed or updated.

(4) Terms “system” and “network” in at least one embodiment is used interchangeably. “At least one” means one or more, and “a plurality of” means two or more. The term “and/or” describes an association relationship of associated objects, and indicates that three relationships exist. For example, A and/or B indicate the following three cases: Only A exists, both A and B exist, and only B exists, where A and B is singular or plural. The character “/” generally indicates an “or” relationship between the associated objects. At least one of the following items (pieces) or a similar expression thereof indicates any combination of these items, including a single item (piece) or any combination of a plurality of items (pieces). For example, “at least one of A, B, and C” includes A, B, C, AB, AC, BC, or ABC. In addition, unless otherwise specified, ordinal numbers such as “first” and “second” in at least one embodiment are used to distinguish between a plurality of objects, and are not used to limit a sequence, a time sequence, priorities, or importance of the plurality of objects.

At least one embodiment is applied to a long term evolution (long term evolution, LTE) system, a new radio (new radio, NR) system, or an NR vehicle to everything (NR vehicle to everything, NR V2X) system; and alternatively is applied to a system of LTE and 5G hybrid networking: or a device-to-device (device-to-device, D2D) communication system, a machine-to-machine (machine to machine, M2M) communication system, an internet of things (Internet of Things, IoT), or an unmanned aerial vehicle communication system: or a communication system that supports a plurality of wireless technologies, for example, an LTE technology and an NR technology: or a non-terrestrial communication system, for example, a satellite communication system or a high-altitude communication platform. In addition, optionally, the communication system is also applicable to a narrow band-internet of things (narrow band-internet of things, NB-IoT) system, an enhanced data rate for GSM evolution (enhanced data rate for GSM evolution, EDGE) system, and a wideband code division multiple access (wideband code division multiple access, WCDMA) system, a code division multiple access 2000 (code division multiple access, CDMA 2000) system, a time division-synchronization code division multiple access (time division-synchronization code division multiple access, TD-SCDMA) system, and a future-oriented communication technology: or another communication system. The communication system includes a network device and a terminal device. The network device is used as a configuration information sending entity, and the terminal device is used as a configuration information receiving entity. Specifically, an entity in the communication system sends configuration information to another entity, and sends data to the another entity, or receives data sent by the another entity. The another entity receives the configuration information, and sends data to the configuration information sending entity based on the configuration information, or receives data sent by the configuration information sending entity. At least one embodiment is applied to a terminal device in a connected state or an active (active) state, or is applied to a terminal device in a non-connected (inactive) state or an idle (idle) state.

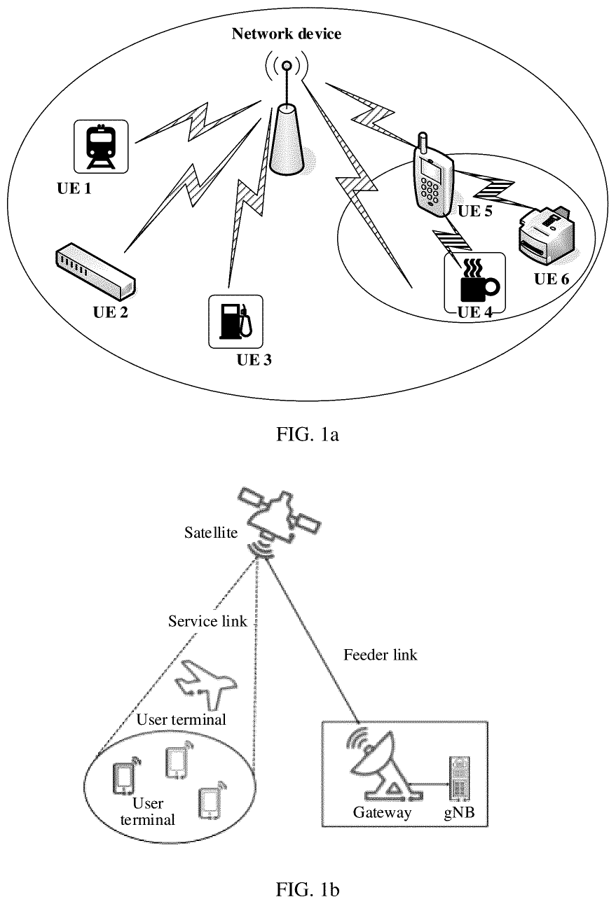

FIG. 1a is a schematic diagram of an application scenario according to at least one embodiment. As shown in FIG. 1a, a configuration information sending entity is a network device, and a configuration information receiving entity is UE 1 to UE 6. In this case, a base station and the UE 1 to the UE 6 form a communication system. In the communication system, the UE 1 to the UE 6 sends uplink data to the network device. The network device is to receive the uplink data sent by the UE 1 to the UE 6. In addition, the network device sends configuration information to the UE 1 to the UE 6.

As shown in FIG. 1a, in a communication process, a sending device (or referred to as a transmit end or a transmitter device) is the network device, and a receiving device (or referred to as a receive end or a receiver device) is a terminal device. Alternatively, a sending device is a terminal device, and a receiving device is the network device. Alternatively, both a sending device and a receiving device is the network devices. Alternatively, both a sending device and a receiving device is terminal devices.

FIG. 1b is a schematic diagram of another application scenario according to at least one embodiment. The communication scenario shown in FIG. 1b is referred to as a satellite communication scenario. In this scenario, a network device includes a satellite device and a gateway (gateway). A terminal device includes an internet of things terminal, or is a terminal of another form and performance, for example, a mobile phone mobile terminal or a high-altitude aircraft. This is not limited herein. A link between a satellite and the terminal device is referred to as a service link (service link), and a link between the satellite and the gateway is referred to as a feeder link (feeder link). The solutions of at least one embodiment are also applied to a multi-satellite communication scenario obtained by extending the communication scenario shown in FIG. 1b.

Optionally, the satellite device is classified into a transparent (transparent) mode and a regenerative (regenerative) mode based on a working mode. In response to the satellite working in the transparent mode, the satellite has a relay and forwarding function. The gateway has functions of a base station or some functions of the base station. In this case, the gateway is considered as the base station.

Optionally, in response to the satellite working in the regenerative mode, the satellite has a data processing capability and functions of a base station or some functions of the base station. In this case, the satellite is considered as the base station.

The technical solutions in at least one embodiment are applicable to a communication system that integrates terrestrial communication and satellite communication. The communication system is also referred to as a non-terrestrial network (non-terrestrial network, NTN) communication system. A terrestrial communication system is, for example, a long term evolution (long term evolution, LTE) system, a universal mobile telecommunications system (universal mobile telecommunications system, UMTS), a 5G communication system or a new radio (new radio, NR) system, or a communication system developed in a next step of the 5G communication system. This is not limited herein.

In comparison with a conventional mobile communication system, the satellite communication has advantages such as wider coverage, support for asymmetric transmission links, irrelevance of communication costs to a transmission distance, and abilities to overcome natural geographical obstacles, for example, oceans, deserts, and mountains. To overcome shortcomings of a conventional communication network, the satellite communication is used as an effective supplement to the conventional network.

In comparison with the terrestrial communication, non-terrestrial network (non-terrestrial network, NTN) communication has different channel features, such as a high transmission delay and a large Doppler frequency shift. For example, a round-trip delay of GEO satellite communication is 238 to 270 milliseconds (ms). A round-trip delay of LEO satellite communication is 8 ms to 20 ms. Based on different orbital altitudes, satellite communication systems are classified into the following three types: a high earth orbit satellite communication system, also referred to as a geostationary earth orbit (geostationary earth orbit, GEO) satellite communication system, a medium earth orbit (medium earth orbit, MEO) satellite communication system, and a low earth orbit (low earth orbit, LEO) satellite communication system.

A GEO satellite is also referred to as a geostationary orbit satellite, and the orbital altitude is 35,786 km (km). A main advantage of the GEO satellite is that the GEO satellite is geostationary and provides a large coverage area. However, the GEO satellite has the following disadvantages: In response to the GEO satellite being at an extremely long distance from the earth, a large-diameter antenna is needed. A transmission delay is high, and is about 0.5 s, and cannot meet a real-time service usage. In addition, the GEO satellite has limited orbit resources and high launch costs, and cannot cover the polar regions. An MEO satellite has an orbital altitude of 2,000 km to 35,786 km, and a small quantity of satellites implements global coverage. However, the MEO satellite has a higher transmission delay than a LEO satellite and is mainly used for positioning and navigation. In addition, a satellite with an orbital altitude of 300 km to 2,000 km is referred to as the low earth orbit (LEO) satellite. In comparison with the MEO satellite and the GEO satellite, the LEO satellite has a lower orbital altitude, a lower data transmission delay, less power loss, and lower launch costs. Therefore, a LEO satellite communication network has made great progress and has been in the spotlight in recent years.

The foregoing content describes a plurality of wireless communication scenarios in at least one embodiment. The foregoing content is merely examples of scenarios to which at least one embodiment is applied. At least one embodiment is further applied to another application scenario. This is not limited herein. The following describes a random access process of wireless communication in at least one embodiment.

In a wireless communication process, a connection is established between the network device and the terminal device through the random access process. The random access process is also referred to as an initial access process, and is generally a process from sending, by a terminal device, a random access preamble to start to attempt to access the network device to establishing a basic signaling connection between the terminal device and the network device.

Currently, the network device broadcasts different synchronization signal/physical broadcast channel blocks (synchronization signal/PBCH blocks, SS/PBCH blocks, or SSBs) for different communication areas, and distinguish between the synchronization signal/physical broadcast channel blocks by using SSB indexes. After receiving an SSB, the terminal device sends the random access preamble based on an uplink resource corresponding to the SSB index. The network device determines, based on the received random access preamble and the corresponding uplink resource, an area in which the terminal device is located, and establish a connection to the terminal device.

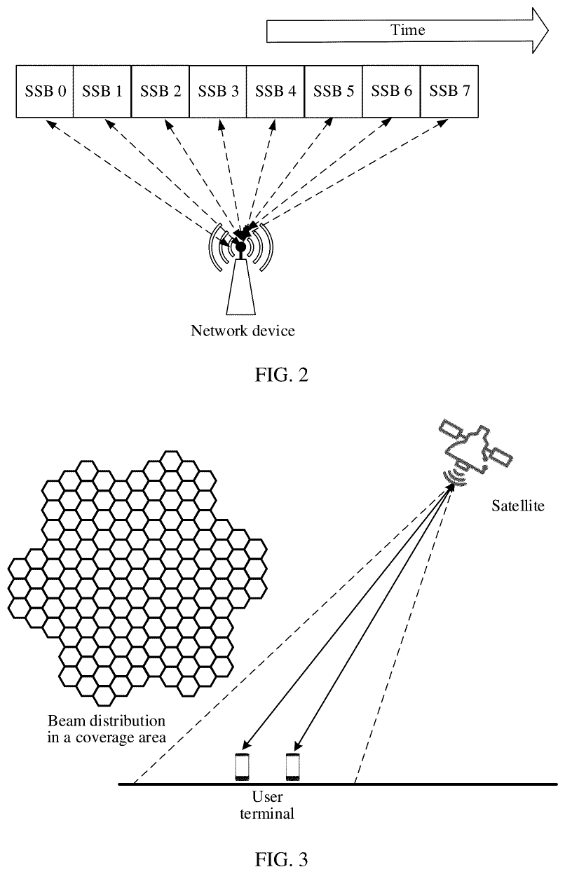

Specifically, the network device broadcasts the SSB in a beam sweeping manner. The terminal device sends, based on the received SSB index, the random access preamble on the uplink resource corresponding to the SSB, and notifies, in this manner, the network device of a beam (beam) selected by the terminal device or in which the terminal device is located. For example, as shown in FIG. 2, different dashed arrow directions indicate different beam directions. The network device broadcasts different SSBs in each beam in a time division manner, and different SSBs carry different SSB indexes. In FIG. 2, an example in which there are eight SSB indexes, including an SSB 0, an SSB 1, . . . , and an SSB 7, is used for description. After detecting (or receiving) the SSB, the terminal device sends the random access preamble based on the SSB index corresponding to the SSB by using a corresponding uplink time-frequency resource, to request to access a network. The network device determines, based on the random access preamble sent by the terminal device and the time-frequency resource on which the random access preamble is located, the beam in which the terminal device is located, to establish an initial beam pair link.

Different beams are distinguished in a protocol based on a bandwidth part (bandwidth part, BWP), a transmission configuration indicator (transmission configuration indicator, TCI), or a synchronization signal block (synchronization signal block, SSB), or in other words, a beam is indicated based on a BWP, a TCI, or an SSB. For example, for the terminal device and the network device, switching between beams is indicated through switching between BWPs, TCIs, or SSBs. Therefore, for the terminal and/or the network device, what is actually performed is the switching between the BWPs, TCIs, or SSBs. In addition, the beam described in at least one embodiment is also replaced with a BWP, a TCI, or an SSB.

To support wider service coverage, the network device is able to provide a network service for a larger communication area. An NTN is used as an example. In the NTN communication system, each satellite/high-altitude platform/base station generally covers a large area. To improve a link budget, the satellite performs narrow beamforming to transmit energy in a centralized manner, so that communication quality of UE in a coverage area is improved. Therefore, a large quantity of beam positions is needed in a coverage area of a single satellite to complete full coverage.

For example, in response to an orbital altitude being 1,150 km and a coverage diameter of a single beam is about 26 km, the coverage area of the satellite is to cover about 700 beam positions. For example, a cellular hexagon in FIG. 3 is used as an example. Each hexagon represents coverage of one beam, and a set of a plurality of hexagons is considered as a coverage area of the satellite. In an initial access phase, the satellite, as a network device, is to sequentially scan all beams, and configure a random access resource for the terminal device. This also increases time spent in beam scanning.

Optionally, in FIG. 3, the hexagon is used as an example of the coverage of the beam. In actual application, the coverage of the beam alternatively is represented by a rectangle, a circle, or another regular shape, or an irregular shape. This is not limited in at least one embodiment.

Optionally, one beam position represents coverage of one beam.

In a current communication system, a quantity of synchronization broadcast blocks that is used is related to a used carrier frequency, for example:
(1) In response to the carrier frequency being lower than 3 GHZ (GHz), a maximum of four SSBs with different SSB indexes are supported in one cell.
(2) In response to the carrier frequency being higher than 3 GHz and lower than 6 GHZ, a maximum of eight SSBs with different SSB indexes are supported in one cell.
(3) In response to the carrier frequency being higher than 6 GHz, a maximum of 64 SSBs with different SSB indexes are supported in one cell.

In conclusion, a maximum quantity of available synchronization broadcast blocks is summarized in Table 1. In response to the carrier frequency being greater than 6 GHz, the maximum quantity of available synchronization broadcast blocks is 64. In an NTN scenario, one satellite supports more than 64 beams. Therefore, a situation in which a quantity of SSBs is insufficient occurs.

TABLE 1

| Subcarrier spacing | | |
|---|---|---|
| (unit: kHz) | Carrier frequency (denoted as f) | Quantity of SSBs |
| 15 | f < 3 GHz | 4 |
| 15 | 3 GHz < f < 6 GHz | 8 |
| 30 | f < 3 GHz | 4 |
| 30 | 3 GHz < f < 6 GHz | 8 |
| 120 | f > 6 GHz | 64 |
| 240 | f > 6 GHz | 64 |

For example, the carrier frequency is higher than 6 GHz. The maximum quantity of available SSBs is 64. The satellite is used as the network device in the communication system. In response to there being 350 beam positions in the coverage area of the satellite, 350 beams are needed to complete full coverage. Division into six cells is needed so that a quantity of SSBs in each cell is not to be greater than 64. In this case, after the satellite moves, the terminal device in the coverage area of the satellite experiences cell switching a plurality of times. In response to the 350 beam positions being mapped to one cell, the cell switching is not performed for the terminal device in the coverage area of the satellite. In other words, in a large-scale beam scenario, in response to a system supporting mapping of a large quantity of beams to one cell, in other words, coverage of the cell is increased, a cell switching frequency in a coverage area of a single satellite is greatly reduced.

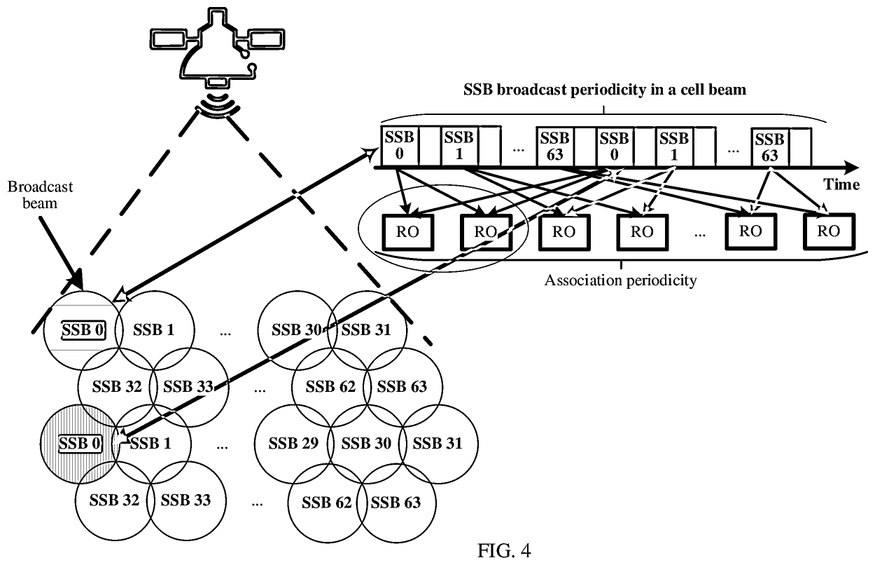

In an implementation example, as shown in FIG. 4, SSBs whose SSB indexes are 0 to 63 in a cell beam is considered as an SSB broadcast periodicity. One broadcast periodicity corresponds to one or more association periodicities (only one association periodicity is shown in the figure, and in this example, each SSB index corresponds to two RO resources in one association periodicity). After receiving an SSB, the terminal device determines a corresponding RO resource in the association periodicity based on the SSB, and send a random access preamble based on the RO resource. In addition, in response to a quantity of beams in a cell being greater than 64, the SSBs whose SSB indexes are 0 to 63 is able to be repeatedly used. In this case, terminal devices in beams corresponding to a same SSB index use a same RO resource. As shown in FIG. 4, in response to an SSB received by a terminal device (denoted as the 1st terminal device) being an SSB 0 to which an “arrow a” points, and an SSB received by another terminal device (denoted as the 2nd terminal device) is an SSB 0 to which an “arrow b” points, the two terminal devices send random access preambles by using a same uplink resource. For the network device, after receiving the random access preambles sent by the two terminal devices, the network device only learns that the two terminal devices are in communication areas corresponding to the “SSB 0”. However, in a scenario shown in FIG. 4, because there are a plurality of communication areas corresponding to the “SSB 0”, the network device cannot distinguish between the first terminal device and the second terminal device that are in the communication areas corresponding to the “SSB 0”.

Similarly, in a terrestrial communication system, in response to a network device providing a network service for a larger communication area, a situation in which a same SSB index is repeatedly used also occurs. Consequently, the network device cannot distinguish between terminal devices in different communication areas.

To resolve the foregoing problem, at least one embodiment provides a communication method and apparatus, so that a network device distinguishes between terminal devices in different communication areas based on time domain positions carrying random access preambles, to improve communication efficiency. The following provides further descriptions with reference to the accompanying drawings.

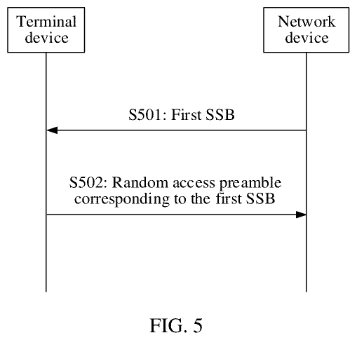

FIG. 5 is a schematic diagram of a communication method according to at least one embodiment. The method includes the following steps.

S501: A terminal device obtains a first SSB.

In this embodiment, a network device sends the first SSB in step S501, and correspondingly, the terminal device receives the first SSB in step S501.

Optionally, in step S501, the terminal device receives the first SSB by using a relay node between the terminal device and the network device.

In response to the network device sending a plurality of SSBs with different SSB indexes, sending length of each SSB index is denoted as an SSB window corresponding to the SSB index, and the network device sends, in the SSB window, one or more SSBs with a same SSB index. In other words, the network device sends one or more same SSBs for each SSB index. For example, in response to a quantity of SSB indexes that is sent by the network device being 64, the network device sends one or more SSBs whose indexes are “SSB 0”, and then send one or more SSBs whose indexes are “SSB 1”. By analogy, the network device sends one or more SSBs whose indexes are “SSB 63”.

Optionally, in response to the network device sending a plurality of same SSBs corresponding to an SSB index, the plurality of same SSBs corresponding to the SSB index is referred to as an SSB group.

Optionally, in response to the quantity of SSB indexes that is sent by the network device being 64, the network device sequentially sends the SSB whose index is “SSB 0”, the SSB whose index is “SSB 1”, . . . , and the SSB whose index is “SSB 63”, and then the network device sends again the SSB whose index is “SSB 0”, the SSB whose index is “SSB 1”, . . . , and the SSB whose index is “SSB 63”. A complete process in which the network device sends “the SSB whose index is ‘SSB 0’, the SSB whose index is ‘SSB 1’, . . . , and the SSB whose index is ‘SSB 63’” is referred to as an SSB set/periodicity.

S502: The terminal device sends a random access preamble corresponding to the first SSB.

In this embodiment, the terminal device sends, in step S502, the random access preamble corresponding to the first SSB, and correspondingly, the network device receives, in step S502, the random access preamble corresponding to the first SSB. The random access preamble is carried at a first time domain position, where the first time domain position is associated with a timing offset value, and the timing offset value is determined based on a round-trip delay between the network device and a first position in an area covered by the network device.

Optionally, in step S502, the network device receives, by using the relay node between the terminal device and the network device, the random access preamble corresponding to the first SSB.

In at least one embodiment, the first time domain position includes one or more random access channel occasions (random access channel occasions, RACH occasions, or ROs), and the terminal device selects one of the one or more ROs as a time/frequency domain resource for carrying the random access preamble corresponding to the first SSB.

Optionally, the first time domain position including the one or more ROs is also referred to as an RO window (window). In other words, the terminal device selects one RO from the RO window as the time domain resource for carrying the random access preamble corresponding to the first SSB.

In at least one embodiment, the first time domain position is obtained by offsetting a first moment based on the timing offset value, and the first moment is associated with the first SSB.

Optionally, this implementation is also expressed as that the first time domain position is located after a second moment obtained by offsetting the first moment by the timing offset value, and the first moment is associated with the first SSB.

Optionally, this implementation is also expressed as that the first time domain position is located after a second moment obtained after the timing offset value offsets the first moment, and the first moment is associated with the first SSB.

Specifically, the time domain position carrying the random access preamble corresponding to the first SSB is obtained based on the first moment associated with the first SSB. In other words, the time domain position is associated with the timing offset value and the first SSB. Because the timing offset values used by terminal devices in different communication areas is different, and the terminal devices in the different communication areas receives the first SSB at different moments, the network device further distinguishes between the terminal devices in the different communication areas based on the timing offset values and the first SSB. For example, the terminal devices in the different areas use different random access resources. Therefore, the network device distinguishes between the terminal devices in the different areas.

In at least one embodiment, the first moment includes at least one of the following: an end moment of a time domain position of the first SSB:
a start moment of a time domain position of the first SSB;
an end moment of a slot in which a time domain position of the first SSB is located;
a start moment of a slot in which a time domain position of the first SSB is located;
an end moment of a time domain position of a second SSB, where the second SSB and the first SSB are located in a same SSB set, and an index of the second SSB is different from an index of the first SSB;
a start moment of a time domain position of a second SSB;
an end moment of a slot in which a time domain position of a second SSB is located: or
a start moment of a slot in which a time domain position of a second SSB is located.

Specifically, the first time domain position carrying the random access preamble is obtained by offsetting the first moment based on the timing offset value, and the first moment is associated with the first SSB. The terminal device determines the first moment based on one or more of the foregoing manners.

In at least one embodiment, there is a plurality of association relationships between the first time domain position carrying the random access preamble and the second moment. The following provides descriptions through a plurality of implementations.

Implementation 1: A start moment of the first time domain position is the second moment.

Specifically, the start moment of the first time domain position carrying the random access preamble corresponding to the first SSB is the second moment, and the second moment is obtained after the timing offset value offsets the first moment. In this way, the first time domain position carrying the random access preamble sent by the terminal device and the second moment are consecutive in time domain, to shorten as much time spent in a random access process.

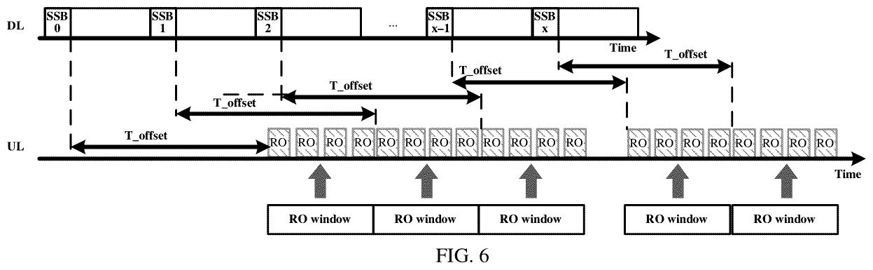

For example, an implementation process shown in FIG. 6 is used as an example. The network device broadcasts SSBs whose SSB indexes are 0 to x (where x is an integer greater than 2). After receiving an SSB, the terminal device determines a range of an RO window based on a time domain position of the SSB and a timing offset value (denoted as T_offset), and send a random access preamble in the RO window.

Optionally, in an example shown in FIG. 6, an example in which the first moment is an end moment of the first SSB is used for description.

Optionally, in FIG. 6, an example in which each RO window includes four RO resources is used for description. A quantity of RO resources included in each RO window alternatively is another value, for example, 1, 2, 3, or another value. This is not limited in at least one embodiment.

An example in which the terminal device receives an SSB whose index is SSB 0 is used. The terminal device offsets backward an end moment of the SSB 0 by a time length of T_offset, to determine a start of the RO window. The terminal device selects any one of the four RO resources included in the RO window corresponding to these SSBs 0 to send the random access preamble.

Optionally, a specific time domain resource (position) of the RO in an RO window length is pre-configured in the terminal device. For example, an implementation example of time domain resource configuration of the RO is shown in Table 2.

TABLE 2

| | | | | | | | Nₜ^{RA, slot}, | |
|---|---|---|---|---|---|---|---|---|
| | | | | | | | number of | |
| | | | | | | | time | |
| | | | | | | | domain | |
| | | | | | | Number of | PRACH | |
| | | | | | | PRACH | occasions | N_{dur}^{RA}, |
| | | | | | | slots | within a | PRACH |
| | | | | | | within a | PRACH | duration |
| | | | | | | subframe | slot | Quantity |
| PRACH | | | | | | nₛₗₒₜ^{RA} | Quantity of | of symbols |
| configuration | | | | | | Quantity of | time | occupied |
| index | | | | | Starting | random | domain | by random |
| Random | Preamble | | | Subframe | symbol | access | ROs | access |
| access | format | | | number | l₀ | slots | included in | time |
| configuration | Preamble | n_{SFN} mod x = y | | Subframe | Starting | included in | a random | domain |
| index | format | x | y | number | symbol | a subframe | access slot | resources |
| 0 | . . . | 1 | 0 | 0, 1, 2, 3, | 0 | 8 | 14 | 1 |
| | | | | 4, 5, 6, 7, | | | | |
| | | | | 8, 9 | | | | |
| 1 | . . . | 1 | 0 | 0, 1, 2, 3, | 0 | 8 | 7 | 2 |
| | | | | 4, 5, 6, 7, | | | | |
| | | | | 8, 9 | | | | |

Parameters in Table 2 are defined as follows:

An orthogonal frequency division multiplexing (orthogonal frequency division multiplexing, OFDM) symbol of the RO in the RO window is l=l₀+nₜ^{RA}N_{dur}^{RA}+14nₛₗₒₜ^{RA}.

l₀ is a position of the starting symbol of the RO.

Nₜ^{RA,slot} indicates a quantity of ROs in the physical random access channel slot (PRACH slot).

N_{dur}^{RA} indicates a quantity of symbols (symbols) occupied by one RO.

nₛₗₒₜ^{RA} indicates a quantity of PRACH slots in a subframe (subframe).

A specific implementation of the parameter “Preamble format preamble format” in Table 2 (and Table 3 and Table 4 below) is not limited in at least one embodiment. For example, a value of the parameter is a pre-configured (or protocol-defined, or pre-stored) preamble format whose index is “A”, where A is a natural number. For ease of description, in at least one embodiment, “ . . . ” is used as an example to represent a name of the preamble format.

NR signaling configuration is still used for frequency domain RO configuration. A higher-layer parameter message 1-frequency division multiplexing (msg1-FDM) indicates 1/2/4/8. NR determines a frequency domain resource position by configuring a position relative to an edge of an initial uplink BWP. An SSB per RO and contention-based preamble per SSB (ssb-perRACH-OccasionAndCB-PreamblesPerSSB) parameter is configured on a network side. The terminal device uses the contention-based preamble per SSB (CB-PreamblesPerSSB) parameter to determine a quantity of used random access preambles. The SSB per RO (ssb-perRACH-Occasion) parameter is not transferred or is not used by the terminal device.

Implementation 2: The first time domain position is located in one or more pieces of time information after the second moment, and the time information includes a frame or a half-frame.

Specifically, the first time domain position carrying the random access preamble corresponding to the first SSB is located in the one or more pieces of time information after the second moment, so that the terminal device determines the first time domain position based on the time information. A more flexible implementation is provided.

Optionally, the time information includes a symbol, a slot, a subframe, or other time information.

Optionally, in the implementation 2, an example in which the time information is the half-frame is used. To be specific, the half-frame is the 1st uplink half-frame obtained after the terminal device offsets an end moment of an SSB window (or a broadcast beam window) by a time length of a timing offset parameter (denoted as T_offset).

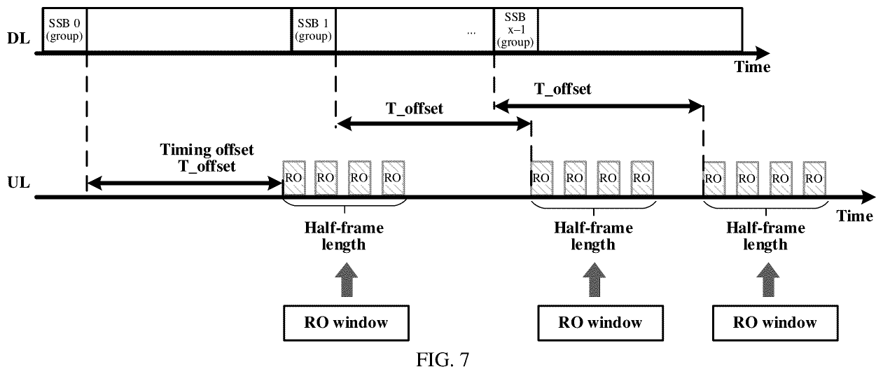

As shown in FIG. 7, an example in which the terminal device receives the SSB whose index is SSB 0 is still used herein. After receiving the SSB 0 (group), the terminal device offsets an end moment of a time window in which the SSB 0 is located by the length of the timing offset parameter, to obtain the second moment, and then the terminal device determines one or more uplink half-frame lengths aligned with the end moment as the RO window.

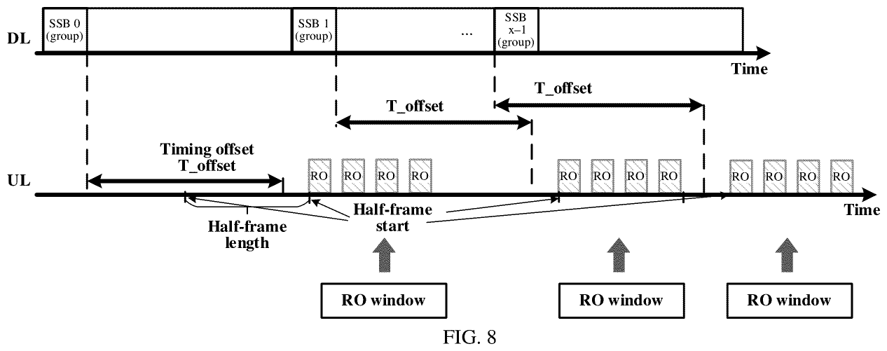

As shown in FIG. 8, a difference from FIG. 7 lies in that a start moment of the RO window is not to be aligned with half-frame timing, to improve flexibility of implementing the solution.

Optionally, in examples shown in FIG. 7 and FIG. 8, an example in which the first moment is the end moment of the first SSB is used for description.

Optionally, for an implementation process of the specific time domain resource (position) of the RO in the RO window length, Table 2 is adaptively modified to obtain another implementation of the specific time domain resource (position) of the RO in the RO window length. For details, refer to descriptions in Table 3 and Table 4.

TABLE 3

| | | Subframe | | | | |
|---|---|---|---|---|---|---|
| | | sequence | | | | |
| | | number in the | | | | |
| | | corresponding | | | Nₜ^{RA, slot}, | |
| | | half-frame | | | number of | |
| | | Subframe | | | time domain | |
| | | including a | | Number of | PRACH | |
| PRACH | | random access | | PRACH | occasions | N_{dur}^{RA}, |
| configuration | Preamble | resource in a | Starting | slots within | within a | PRACH |
| index | format | half-frame | symbol | a subframe | PRACH slot | duration |
| 0 | . . . | 0 | 0 | 1 | 2 | 2 |
| 1 | . . . | 0, 1 | 0 | 1 | 4 | 2 |
| 2 | . . . | 0, 1, 2 | 0 | 1 | 2 | 2 |
| 3 | . . . | 0, 1, 2, 3 | 0 | 1 | 2 | 2 |
| 4 | . . . | 0, 1, 2, 3, 4 | 0 | 1 | 2 | 2 |
| . . . | . . . | Subset ∈ {0, | 0 | ∈ {1, 2} | ∈ {1 to 14} | ∈ {1 to 14} |
| | | 1, 2, 3, 4} | | | | |
| . . . | . . . | Subset ∈ {0, | 0 | ∈ {1 to 8} | ∈ {1 to 14} | ∈ {1 to 14} |
| | | 1, 2, 3, 4} | | | | |

Optionally, each broadcast beam scans all beam positions (for example, 700 or 360 beam positions) in a coverage area of a satellite. A receive beam of the broadcast beam radiates each beam position for 5 ms. In response to the beam position being radiated for another time length, a parameter related to the subframe number (Subframe number) in the foregoing table is to be modified accordingly. For example, the name of the subframe including a random access resource in a half-frame (Subframe sequence number in the corresponding half-frame) is changed to subframe sequence number corresponding to an RO window (Subframe sequence number in the corresponding RO window).

Optionally, in Table 3, a subcarrier spacing (subcarrier spacing, SCS) corresponding to the random access preamble has a plurality of values.

For example, in response to the SCS value being 15 kHz, Number of PRACH slots within a subframe=1. In response to the SCS value being 30 kHz, Number of PRACH slots within a subframe=1 or 2. In response to the SCS value being 60 kHz, Number of PRACH slots within a subframe={1, 2, 3, 4}. In response to the SCS value being 120 kHz, Number of PRACH slots within a subframe={1 to 8}.

Optionally, the network device configures an RO window length for the terminal device or agree on an RO window length by using a protocol. For example, according to an agreement, the RO window length is a residence time length of a broadcast beam, and the RO window is aligned with a half-frame boundary.

Optionally, the RO window length alternatively is another value, and corresponds to a time length (the beam residence time length) of irradiating a beam position by the broadcast beam or a time length of an SSB (group) window.

TABLE 4

| | | | | | | | Nₜ^{RA, slot}, | |
|---|---|---|---|---|---|---|---|---|
| | | | | | | | number of | |
| | | | | | | Number of | time domain | |
| | | | | | | PRACH | PRACH | |
| PRACH | | | | | | slots | occasions | N_{dur}^{RA}, |
| configuration | Preamble | n_{SFN} mod x = y | | Subframe | Starting | within a | within a | PRACH |
| index | format | x | y | number | symbol | subframe | PRACH slot | duration |
| 0 | . . . | 1 | 0 | {0}{5} | 0 | 1 | 2 | 2 |
| 1 | . . . | 1 | 0 | {0, 1}{5, | 0 | 1 | 4 | 2 |
| | | | | 6} | | | | |
| 2 | . . . | 1 | 0 | {0, 1, | 0 | 1 | 2 | 2 |
| | | | | 2}{5, 6, 7} | | | | |
| 3 | . . . | 1 | 0 | {0, 1, 2, | 0 | 1 | 2 | 2 |
| | | | | 4}{5, 6, 7, | | | | |
| | | | | 8} | | | | |
| 4 | . . . | 1 | 0 | {0, 1, 2, 3, | 0 | 1 | 2 | 2 |
| | | | | 4}{5, 6, 7, | | | | |
| | | | | 8, 9} | | | | |
| . . . | . . . | 1 | 0 | Subset ∈ | 0 | ∈ {1, 2} | ∈ {1 to 14} | ∈ {1 to 14} |
| | | | | {0, 1, 2, 3, | | | | |
| | | | | 4} | | | | |
| | | | | Subset ∈ | | | | |
| | | | | {5, 6, 7, 8, | | | | |
| | | | | 9} | | | | |
| . . . | . . . | 1 | 0 | Subset ∈ | 0 | ∈ {1 to 8} | ∈ {1 to 14} | ∈ {1 to 14} |
| | | | | {0, 1, 2, 3, | | | | |
| | | | | 4} | | | | |
| | | | | Subset ∈ | | | | |
| | | | | {5, 6, 7, 8, | | | | |
| | | | | 9} | | | | |

In a subframe number option, the two sets respectively represent a subframe number of an RO in an upper half-frame and a subframe number of an RO in a lower half-frame. In response to the RO window length being 5 ms, the upper half-frame and the lower half-frame respectively correspond to two RO windows. Table 3 is configured based on a subframe including a random access resource in a half-frame, and Table 4 is configured based on both the upper half-frame and the lower half-frame in a frame.

Implementation 3: The first time domain position is located in k association periodicities adjacent to the second moment.

The association periodicity is a periodicity of an RO resource corresponding to an SSB set in which the first SSB is located, and k is an integer greater than 0.

Specifically, the first time domain position carrying the random access preamble corresponding to the first SSB is located in the k association periodicities adjacent to the second moment. The association periodicity is the periodicity of the RO resource corresponding to the SSB set in which the first SSB is located. In other words, in response to the corresponding RO resource being pre-configured in the SSB set, the terminal device sends the random access preamble on the pre-configured RO resource based on the first SSB, to improve a random access success rate.

For example, assuming that an SSB 0 to an SSB x are broadcast in a system, a minimum quantity of PRACH RO configuration periodicities that are used in response to all the SSB 0 to the SSB x being mapped to ROs is referred to as an association periodicity (association period). The association periodicity starts from a frame 0. The PRACH RO configuration periodicity is obtained based on an RO configuration table. For example, as shown in Table 4, the RO configuration periodicity is 10 ms.

Optionally, the terminal device determines, based on the received SSB, an SSB set (a synchronization broadcast block set) in which the terminal device is located, and determines, by using a timing offset T_offset, an RO association periodicity mapped to the SSB set.

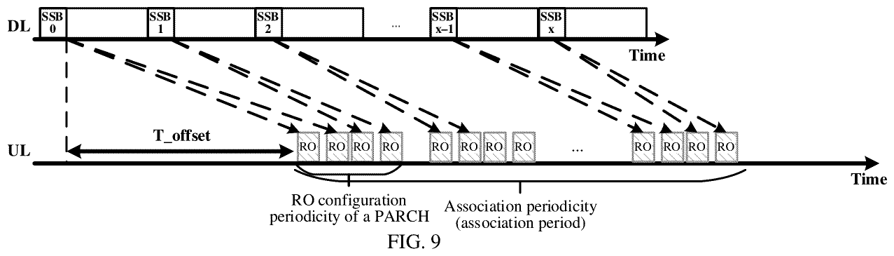

Specifically, as shown in FIG. 9, the terminal device determines, based on a received SSB index and a known SSB pattern (determined according to a protocol), a time domain position of the SSB set in which the SSB is located, determines a time domain position of the SSB 0, offsets an end or start position of the SSB 0 by a time length of the timing offset T_offset, determines a moment obtained by offsetting as a start of the RO association periodicity of the SSB set, and agrees on that the SSB 0 to the SSB x are associated with an RO in only one or y (where y is an integer greater than or equal to 1) association periodicities. The terminal device sends, in the association periodicity, the preamble by using an RO resource mapped to a detected SSB index.

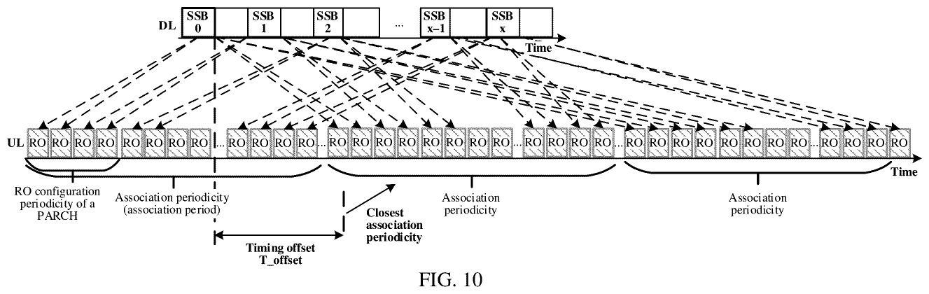

Optionally, as shown in FIG. 10, the terminal device maps the association periodicity to the SSB 0 to the SSB x from the frame 0. The terminal device determines, based on the detected SSB and the known SSB pattern (determined according to the protocol), the time domain position of the SSB set in which the SSB is located, determines the time domain position of the SSB 0, offsets the end or start position of the SSB 0 by the time length of the timing offset T_offset, and selects an RO resource in a closest RO association periodicity as an RO resource mapped to the SSB set. Alternatively, the terminal device selects an RO resource in closest y (where y is an integer greater than or equal to 1) RO association periodicities as an RO resource mapped to the SSB set. The terminal device sends, in the selected one or y association periodicities, the preamble by using the RO resource mapped to the detected SSB index.

Optionally, in examples shown in FIG. 9 and FIG. 10, an example in which the first moment is an end moment of the 1st SSB in the SSB set in which the first SSB is located is used for description. For example, in response to an index of the first SSB being “SSB 0”, the first moment is the end moment of the first SSB. In response to the index of the first SSB being another value, the first moment is an end moment of the second SSB. An index of the second SSB is “SSB 0”.

In at least one embodiment, the method further includes: The terminal device obtains the timing offset value. Specifically, the terminal device receives the timing offset value sent by the network device, so that the timing offset value used by the terminal device is determined between the network device and the terminal device and the random access preamble is obtained, to improve the random access success rate.

Optionally, the terminal device obtains the timing offset value via an indication of a relay node between the terminal device and the network device.

Optionally, the network device that sends the timing offset value to the terminal device and the network device that sends the first SSB to the terminal device is a same network device, or is different network devices. This is not limited herein.

Optionally, the timing offset value is pre-configured in the terminal device.

For example, the network device configures the timing offset value (denoted as T_offset) for the terminal device. For example, T_offset=[RTD_max/subframe_length]=15 ms, where [.] represents rounding up, RTD_max represents a maximum round-trip delay between a base station to the terminal device, and subframe_length represents a subframe length, or subframe_length is replaced with a slot length or a symbol length. The slot length is determined based on an uplink subcarrier width used by the terminal device, or a slot length corresponding to a subcarrier width (for example, a slot length of 1 ms corresponding to a subcarrier width of 15 kHz) is agreed on.

Optionally, a value of the timing offset value is related to a value of an offset Koffset value, where the Koffset value is used to determine a scheduling interval of a physical uplink shared channel (physical uplink shared channel, PUSCH) signal.

Optionally, the value of the timing offset value is the same as the value of the offset Koffset value, or the value of the timing offset value and the value of the offset Koffset value meet a specific mathematical relationship.

Specifically, the value of the timing offset value is related to the value of the offset Koffset value. In other words, the terminal device determines the value of the timing offset value based on the value of the offset Koffset value, so that a process of determining the timing offset value is based on related configuration information of the offset Koffset value, to reduce signaling overheads.

In other words, to reduce the signaling overheads, T_offset is set to be equal to an existing parameter value, and the parameter value is related to the maximum round-trip delay between the terminal device and the base station. For example, the network side sends a time offset Koffset value to the terminal device, to indicate a scheduling interval of an PUSCH signal. In response to the terminal device receiving uplink grant/scheduling information in a downlink slot n, PUSCH data of the terminal device is to be sent in an uplink slot

$$⌊ n \cdot \frac{{2}^{{μ}_{PUSCH}}}{{2}^{{μ}_{PDCCH}}} ⌋ + {K}_{2} + {K}_{offset} .$$

K₂=0, . . . ,32, and a value of K₂ is indicated by a DCI instruction. μ_{PUSCH} and μ_{PDCCH} are related to subcarrier spacings of a PUSCH and a PDCCH. To be specific, the subcarrier spacing of the PUSCH is 2^{μ}^{_{PUSCH}}×15 KHz, and the subcarrier spacing of the PDCCH is 2^{μ}^{_{PDCCH}}×15 kHz. Therefore, T_offset=a Koffset value or a time length represented by T_offset is the same as a time length represented by Koffset.

In at least one embodiment, that the terminal device sends a random access preamble corresponding to the first SSB includes: The terminal device sends, based on first information, the random access preamble corresponding to the first SSB, where the first information includes at least one of the following:
a time length of the first time domain position;
a quantity of random access channel occasion RO resources included in the first time domain position, where the RO resource is used to carry the random access preamble: or
a quantity of SSBs corresponding to the first time domain position.

Specifically, the first time domain position includes one or more ROs. The terminal device determines, based on the first information, the first time domain position carrying the random access preamble. The first information includes at least one of the following: the time length of the first time domain position, the quantity of ROs included in the first time domain position, or the quantity of SSBs corresponding to the first time domain position, so that the terminal device determines the first time domain position based on the first information.

In at least one embodiment, the method further includes: The terminal device obtains the first information. Specifically, the terminal device receives the first information sent by the network device, so that the first information used by the terminal device is determined between the network device and the terminal device and the random access preamble is obtained, to improve the random access success rate.

Optionally, the terminal device obtains the first information via an indication of a relay node between the terminal device and the network device.

Optionally, the network device that sends the first information to the terminal device and the network device that sends the first SSB to the terminal device is a same network device, or is different network devices. This is not limited herein.

Optionally, the first information is pre-configured in the terminal device.

The following describes a plurality of implementations of the first information by using examples.

In response to the first information including the time length of the first time domain position, the network device configures an RO window length ROwindow_length for the terminal device. For example, ROwindow_length=4 symbol_length, where symbol_length represents a symbol length, and includes a CP (cyclic prefix) length. Alternatively, the ROwindow_length is represented in another time unit, for example, a millisecond and a slot length. For example, ROwindow_length=1 ms.

Optionally, the terminal device offsets backward an end moment of a detected SSB by a time length indicated by T_offset, and a moment obtained by offsetting is used as a start of an RO window. The RO window ends in the time length ROwindow_length. The RO window is used as an RO window mapped to the SSB.

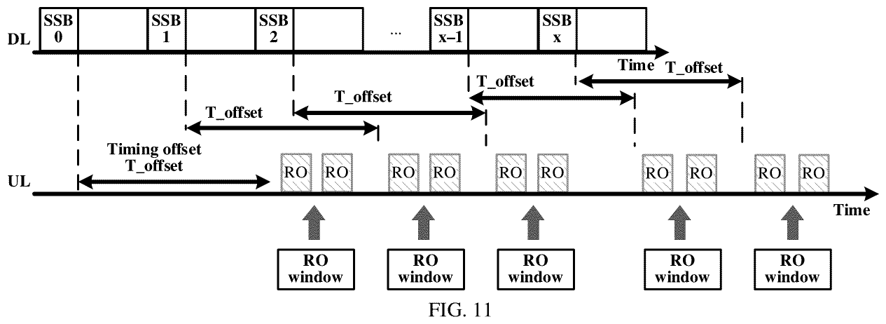

The first information includes the quantity of random access channel occasion RO resources included in the first time domain position, where the RO resource is used to carry the random access preamble. An implementation in FIG. 11 is used as an example. The network device sends an RO window parameter ROwindow_length to the terminal device to indicate the quantity of RO resources. For example, the RO window=2 RO resources. A value of ROwindow_length reuses the ssb-perRACH-Occasion parameter, that is, ROwindow_length=ssb-perRACH-Occasion. In this case, ssb-perRACH-Occasion is an integer greater than 0.

Optionally, the terminal device offsets backward the end moment of the detected SSB by a time length of T_offset, and selects ROwindow_length=2 complete ROs thereafter as ROs mapped to the RO window or the SSB.

The first information includes the quantity of SSBs corresponding to the first time domain position. Specifically, a difference from the foregoing implementation processes lies in that a parameter SSBperROwindow is added to indicate that each RO window corresponds to SSBperROwindow SSBs, so that a plurality of SSBs share a same RO window. In this case, an RO window length is not greater than a length of [SSBperROwindow x SSB launch interval] or a length [Time occupied by SSBperROwindow SSBs]. The base station sends the parameter SSBperROwindow to the terminal device. An SSBperROwindow value reuses the ssb-perRACH-Occasion parameter, that is, SSBperROwindow=1/ssb-perRACH-Occasion. In this case, 0<ssb-perRACH-Occasion<1.

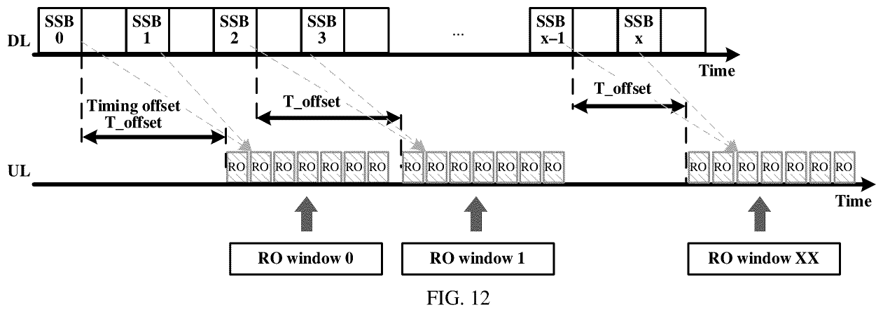

For example, the network side sends SSBperROwindow=2 to the terminal device to indicate that each RO window corresponds to two SSBs. As shown in FIG. 12, the SSB 0/SSB 1 is mapped to an RO window 0. The RO window 0 is determined based on the end moment of the SSB 0. Similarly, an SSB 2/SSB 3 is mapped to an RO window 1. The RO window 1 is determined based on an end moment of the SSB 2. Specific steps are as follows (it is assumed that SSB indexes broadcast by the base station are 0 to 63: in response to the SSB index being another combination, a principle is the same):

(1) The terminal device divides 0 to 63 into 64/SSBperROwindow groups. In response to SSBperROwindow=2, the terminal device divides the SSB indexes into 32 groups: {SSB 0 SSB 1}, {SSB 2 SSB 3}, {SSB 4 SSB 5}, . . .

(2) After detecting an SSB index, the terminal device determines the RO window based on an end moment of the 1st SSB in an SSB group in which the SSB index is located (where the terminal device determines an end position of the SSB based on an SSB pattern). The RO window is mapped to the SSB, and the terminal device selects an RO in the RO window to send the preamble.

Optionally, after detecting an SSB index, the terminal device determines the RO window based on an end moment of the last SSB in an SSB group in which the SSB index is located (where the terminal device determines an end position of the SSB based on an SSB pattern).

In this case, different preambles mapped to different SSBs are used to distinguish between beam coverage areas in which the terminal device is located. Therefore, in a scenario in which users are unevenly distributed in different beams, RO resources are fully utilized to reduce an access collision probability and improve a detection rate.

In the signaling in at least one embodiment, for example, any one of a plurality of pieces of information such as a time length (which is denoted as ROwindow_length) of the first time domain position included in the first information, a quantity (which is denoted as SSBperROwindow) of random access channel occasion RO resources, a quantity (which is denoted as SSBperROwindow) of SSBs corresponding to the first time domain position, a timing offset value (which is denoted as T_offset), and second information mentioned below is included in at least one of the following broadcast information: a system information block (system information block, SIB) 1, other system information (other system information, OSI), a master system information block (mater information block, MIB), and the like. The signaling is sent by the network device to a terminal device in a broadcast or multicast manner. Sending the signaling to the terminal device in the broadcast or multicast manner avoids scheduling different resources for different terminal devices for the purpose of sending the signaling, thereby reducing signaling overheads for scheduling resources and reducing system scheduling complexity.

In addition, in response to any one or more of the plurality of pieces of information being sent in a radio resource control (radio resource control, RRC) connection establishment phase and a subsequent communication process, the network device adds the foregoing signaling to at least one of the following information: RRC signaling (for example, an RRC setup (RRCsetup) message, RRC reconfiguration signaling (RRCReconfiguration), or RRC resume signaling (RRCResume)), downlink control information (downlink control information, DCI), group DCI, a media access control (media access control, MAC) control element (control element, CE), or a timing advance command (timing advance command, TAC), or indicate the foregoing signaling/parameter value to the terminal device in a table, or send the information to the terminal device in a unicast or multicast manner along with data transmission or on a separately allocated PDSCH bearer. An advantage of sending the signaling to the terminal device separately or in a group is that a parameter value of each terminal device/each group of terminal devices is flexibly controlled, and different parameter values are configured for the terminal device based on different positions or different areas in which the terminal device is located, to optimize a system parameter and communication performance of the terminal device/communication performance of a system. For example, a maximum round-trip delay between the terminal device and the base station is determined based on a specific position or an approximate position or area of the terminal device, to determine a precise T_offset value. Different T_offset values is configured for the terminal device, to reduce an access delay of each terminal device/each group of terminal devices, and improve communication efficiency between the terminal device and the system.

In at least one embodiment, the first time domain position is associated with the timing offset value and second information, and the second information includes at least one of the following:
n first preset values, where n indicates an index position of the first SSB in the SSB set, n is a natural number, for example, in response to the index of the first SSB being SSB 0, the index position of the first SSB in the SSB set is “0”, that is, a value of n is 0; in response to the index of the first SSB being SSB 1, the index position of the first SSB in the SSB set is “1”, that is, a value of n is 1, . . . , and so on, and n alternatively is another value;
processing delay information;
positioning error information: or
ephemeris error information.

Specifically, the terminal device determines, based on the second information, the first time domain position carrying the random access preamble. In response to the second information including the n first preset values, the first time domain position is not limited by an SSB interval. In response to the second information including at least one of the processing delay information, the positioning error information, and the ephemeris error information, accurate processing duration is reserved for the terminal device, to improve the random access success rate.

The following describes a plurality of implementations of the second information by using examples.

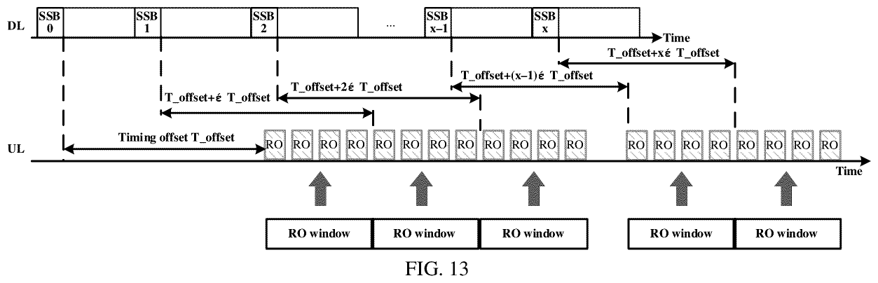

In an implementation in which the second information includes the n first preset values, a parameter ΔT_offset is added, so that the RO window length is no longer limited by the SSB interval. For example, assuming that an interval between the SSB 0 and the SSB 1 is 2 ms, the RO window length ROwindow_length sent by the base station to the terminal device based on the solution in the foregoing embodiment cannot be greater than 2 ms. In response to the RO window length being greater than 2 ms, an RO window corresponding to the SSB 0 and an RO window corresponding to the SSB 1 overlap with each other, and mapping between an RO resource and the SSB is confused. As shown in FIG. 13, adding the parameter ΔT_offset is equivalent to increasing a distance between a start moment of the RO window corresponding to the SSB 0 and a start moment of the RO window corresponding to the SSB 1. A longer RO window length is configured for the terminal device, in other words, a maximum RO window length is equal to a sum of the SSB interval and a time length of ΔT_offset.

Optionally, the network side sends the timing offset value T_offset and the timing offset difference ΔT_offset (in other words, a first preset value is denoted as the timing offset difference ΔT_offset) to the terminal device. Then, the terminal device determines, based on a detected SSB index x (where x=0, 1, 2 . . . ), that a to-be-used timing offset value is denoted as T_offset_use (that is, n is denoted as x). T_offset_use meets:

$$T\_offset \_use = T\_offset + ΔT\_offset \times x ;$$

For example, in response to the SSB index detected and selected by the terminal device being 3, the timing offset value to be used by the terminal device is T_offset_use=T_offset+ΔT_offset xx, where a value of x is 3.

In an implementation in which the second information includes a processing delay, in response to the processing delay being considered, an offset A value is added to a T_offset value, to adapt to impact of processing delays of different devices. T_offset+Δ represents a time offset length of the RO window relative to the end moment of the SSB. A value of Δ is agreed on by using a protocol. For example, Δ is agreed on to be 1 ms or a slot length. Alternatively, the offset value Δ is configured for the terminal device through the network side. For example, the offset value Δ is a length of two slots or a length of two data symbols (symbols). In this case, the terminal device uses T_offset+4 as the timing offset value. T_offset+Δ indicates that a time length represented by T_offset and a time length represented by Δ are added. In response to time units of the two time lengths being different, simple time conversion is performed to obtain a same unit.

In an implementation in which the second information includes the positioning error information or the ephemeris error information, the network device delivers the positioning error information or the ephemeris error information to the terminal device, so that the terminal device processes the timing offset value based on the positioning error information or the ephemeris error information, to eliminate an error, and improve the random access success rate.

In at least one embodiment, the first position includes any one of the following: a position that is within cell coverage and that is farthest from the network device, a position that is within beam coverage and that is farthest from the network device, and a position of the terminal device.

Based on the foregoing technical solution, the timing offset value is determined based on the round-trip delay between the first position in the area covered by the network device and the network device. The network device configures a common timing offset value for a plurality of terminal devices in the coverage area. In other words, the first position is the position that is within the cell coverage and that is farthest from the network device, or the position that is within the beam coverage and that is farthest from the network device. This helps reduce the signaling overheads. Alternatively, the network device separately configures a timing offset value for the terminal device in the coverage area. In other words, the first position is the position of the terminal device. This helps improve accuracy.

Based on the foregoing technical solution, after obtaining the first SSB in step S501, the terminal device sends, in step S502 based on the first time domain position associated with the timing offset value, the random access preamble corresponding to the first SSB. The timing offset value is determined based on the round-trip delay between the first position in the area covered by the network device and the network device. In other words, timing offset values used by terminal devices in different communication areas is different. Therefore, after the terminal devices in the different communication areas receive SSBs, because the time domain position carrying the random access preamble sent by the terminal device is associated with the timing offset value, the network device distinguishes between the terminal devices in the different communication areas based on the time domain position carrying the random access preamble, to improve communication efficiency.

In at least one embodiment, different from the implementation processes in FIG. 6 to FIG. 13, the network device further distinguishes between terminal devices in different communication areas in another manner. In this implementation, a representation range of an SSB index is extended.

In this implementation, the index of the first SSB obtained by the terminal device in step S501 is determined by third information, and a quantity of bits included in the third information is greater than or equal to 6. Then, the terminal device sends, in step S502, the random access preamble corresponding to the first SSB.

Optionally, the third information includes at least one of the following: one spare (spare) bit on a physical broadcast channel (physical broadcast channel, PBCH), one bit of intra-frequency reselection (intraFreReselection) (which indicates whether the intra-frequency cell reselection is allowed), and one bit of a choice (Choice) parameter (which indicates whether a master information block message (master information block, MIB) is extended).

In this implementation, an existing configuration manner is still used, provided that each SSB (group) has a corresponding RO resource in a beam position scanning periodicity.

As shown in the foregoing Table 1, in response to the carrier frequency ≥6 GHZ, an SSB index parameter (including 3 bits) in the physical broadcast channel (physical broadcast channel, PBCH) indicates three most significant bits of the SSB index, and a bearer of (including 3 bits) a demodulation reference signal (demodulation reference signal, DMRS) of the PBCH indicates three least significant bits of the SSB index. In response to the carrier frequency <6 GHZ, one bit of the SSB index parameter (including three bits) in the PBCH indicates an SSB subcarrier offset, and the remaining two bits are spare bits. However, in this implementation, one spare (spare) bit in the PBCH, one bit of an intra-frequency reselection (intraFreReselection) parameter (which indicates whether the intra-frequency cell reselection is allowed), and one bit of a choice (Choice) parameter (which indicates whether a master information block message (master information block, MIB) is extended) indicates the SSB index, to be specific, indicate the three most significant bits of the SSB index. In this way, the SSB index has 9 bits in total, and represents a maximum of 512 beam position (beam) numbers. Therefore, in response to the network device providing a network service for a larger communication area, more SSB indexes are indicated by extending the bit that indicates the SSB index, so that the network device distinguishes between terminal devices in different communication areas.

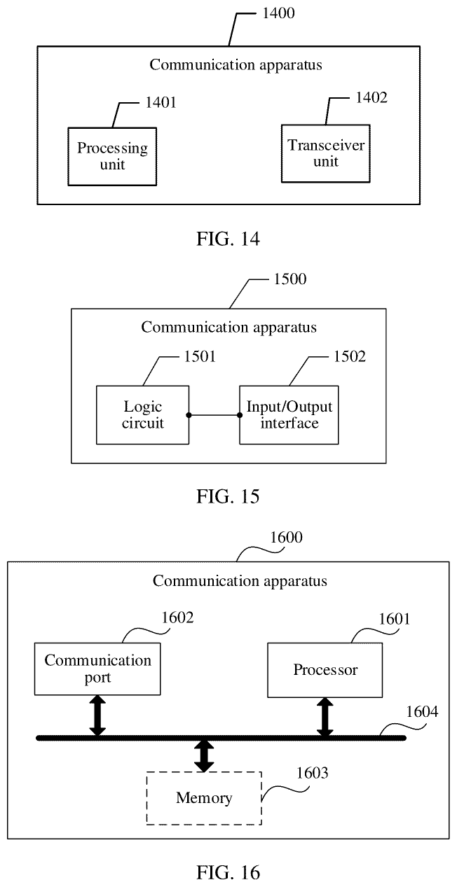

Refer to FIG. 14. At least one embodiment provides a communication apparatus 1400. The communication apparatus 1400 implements functions of the terminal device (or the network device) in the foregoing method embodiments, and therefore also implements beneficial effects of the foregoing method embodiments. In at least one embodiment, the communication apparatus 1400 is a terminal device (or a network device), or is an integrated circuit or an element, for example, a chip, in the terminal device (or the network device). In the following embodiment, an example in which the communication apparatus 1400 is a terminal device or a network device is used for description.

In at least one embodiment, in response to the apparatus 1400 being configured to perform the method performed by the terminal device in any one of the foregoing embodiments, the apparatus 1400 includes a processing unit 1401 and a transceiver unit 1402.

The transceiver unit 1402 is configured to obtain a first synchronization signal block SSB.

The processing unit 1401 is configured to determine a random access preamble corresponding to the first SSB.

The transceiver unit 1402 is configured to send the random access preamble corresponding to the first SSB, where the random access preamble is carried at a first time domain position, the first time domain position is associated with a timing offset value, and the timing offset value is determined based on a round-trip delay between the network device and a first position in an area covered by the network device.

In at least one embodiment, the first time domain position is obtained by offsetting a first moment based on the timing offset value, and the first moment is associated with the first SSB.

In at least one embodiment, the first time domain position is located after a second moment obtained by offsetting the first moment by the timing offset value.

In at least one embodiment, the first time domain position is located after a second moment obtained after the timing offset value offsets the first moment, and the first moment is associated with the first SSB.

In at least one embodiment, a start moment of the first time domain position is the second moment.

In at least one embodiment, the first time domain position is located in one or more pieces of time information after the second moment, and the time information includes a frame or a half-frame.

In at least one embodiment, the first time domain position is located in k association periodicities adjacent to the second moment, the association periodicity is a periodicity of an RO resource corresponding to an SSB set in which the first SSB is located, and k is an integer greater than 0.

In at least one embodiment, the first moment includes at least one of the following: an end moment of a time domain position of the first SSB:
a start moment of a time domain position of the first SSB;
an end moment of a slot in which a time domain position of the first SSB is located;
a start moment of a slot in which a time domain position of the first SSB is located;
an end moment of a time domain position of a second SSB, where the second SSB and the first SSB are located in a same SSB set, and an index of the second SSB is different from an index of the first SSB;
a start moment of a time domain position of a second SSB;
an end moment of a slot in which a time domain position of a second SSB is located; or
a start moment of a slot in which a time domain position of a second SSB is located.

In at least one embodiment,
the transceiver unit 1402 is further configured to obtain the timing offset value.

In at least one embodiment, that the transceiver unit 1402 is configured to send the random access preamble corresponding to the first SSB includes:

The transceiver unit 1402 is configured to send, based on first information, the random access preamble corresponding to the first SSB, where the first information includes at least one of the following:
a time length of the first time domain position;
a quantity of random access channel occasion RO resources included in the first time domain position, where the RO resource is used to carry the random access preamble: or
a quantity of SSBs corresponding to the first time domain position.

In at least one embodiment, the transceiver unit 1402 is further configured to obtain the first information.

In at least one embodiment, the first time domain position is associated with the timing offset value and second information, and the second information includes at least one of the following:
n first preset values, where n indicates an index position of the first SSB in the SSB set, and n is a natural number;
processing delay information;
positioning error information: or
ephemeris error information.

In at least one embodiment, a value of the timing offset value is related to a value of an offset Koffset value, where the Koffset value is used to determine a scheduling interval of a physical uplink shared channel PUSCH signal.

In at least one embodiment, the first position includes any one of the following:
a position that is within cell coverage and that is farthest from the network device, a position that is within beam coverage and that is farthest from the network device, and a position of the terminal device.

In at least one embodiment, in response to the apparatus 1400 being configured to perform the method corresponding to the network device in any one of the foregoing embodiments, the apparatus 1400 includes a processing unit 1401 and a transceiver unit 1402.

The processing unit is configured to determine a first synchronization signal block SSB.

The transceiver unit 1402 is configured to send the first synchronization signal block SSB.

The transceiver unit 1402 is configured to obtain a random access preamble corresponding to the first SSB, where the random access preamble is carried at a first time domain position, the first time domain position is associated with a timing offset value, and the timing offset value is determined based on a round-trip delay between the network device and a first position in an area covered by the network device.

In at least one embodiment, the first time domain position is obtained by offsetting a first moment based on the timing offset value, and the first moment is associated with the first SSB.

In at least one embodiment, the first time domain position is located after a second moment obtained by offsetting the first moment by the timing offset value.

In at least one embodiment, the first time domain position is located after a second moment obtained after the timing offset value offsets the first moment, and the first moment is associated with the first SSB.

In at least one embodiment, a start moment of the first time domain position is the second moment.

In at least one embodiment, the first time domain position is located in one or more pieces of time information after the second moment, and the time information includes a frame or a half-frame.

In at least one embodiment, the first time domain position is located in k association periodicities adjacent to the second moment, the association periodicity is a periodicity of an RO resource corresponding to an SSB set in which the first SSB is located, and k is an integer greater than 0.

In at least one embodiment, the first moment includes at least one of the following: an end moment of a time domain position of the first SSB:
a start moment of a time domain position of the first SSB;
an end moment of a slot in which a time domain position of the first SSB is located;
a start moment of a slot in which a time domain position of the first SSB is located;
an end moment of a time domain position of a second SSB, where the second SSB and the first SSB are located in a same SSB set, and an index of the second SSB is different from an index of the first SSB;
a start moment of a time domain position of a second SSB;
an end moment of a slot in which a time domain position of a second SSB is located; or
a start moment of a slot in which a time domain position of a second SSB is located.

In at least one embodiment, the transceiver unit 1402 is further configured to send the timing offset value.

In at least one embodiment, that the transceiver unit 1402 is configured to obtain a random access preamble corresponding to the first SSB includes:

The transceiver unit 1402 is configured to obtain, based on first information, the random access preamble corresponding to the first SSB, where the first information indicates at least one of the following:
a time length of the first time domain position;
a quantity of random access channel occasion RO resources included in the first time domain position, where the RO resource is used to carry the random access preamble: or a quantity of SSBs corresponding to the first time domain position.

In at least one embodiment, the transceiver unit 1402 is further configured to send the first information.

In at least one embodiment, the first time domain position is associated with the timing offset value and second information, and the second information includes at least one of the following:
n first preset values, where n indicates an index position of the first SSB in the SSB set, and n is a natural number;
processing delay information;
positioning error information: or
ephemeris error information.

In at least one embodiment, a value of the timing offset value is related to a value of an offset Koffset value, where the Koffset value is used to determine a scheduling interval of a physical uplink shared channel PUSCH signal.

In at least one embodiment, the first position includes any one of the following:
a position that is within cell coverage and that is farthest from the network device, a position that is within beam coverage and that is farthest from the network device, and a position of the terminal device.

For content such as an information execution process of the units in the communication apparatus 1400, refer to the descriptions in the foregoing method at least one embodiment. Details are not described herein again.

FIG. 15 is a schematic diagram of another structure of a communication apparatus 1500 according to at least one embodiment. The communication apparatus 1500 includes at least an input/output interface 1502. The communication apparatus 1500 is a chip or an integrated circuit.

Optionally, the communication apparatus further includes a logic circuit 1501.

The transceiver unit 1402 shown in FIG. 14 is a communication interface. The communication interface is the input/output interface 1502 in FIG. 15. The input/output interface 1502 includes an input interface and an output interface. Alternatively, the communication interface is a transceiver circuit, and the transceiver circuit includes an input interface circuit and an output interface circuit.

Optionally, the input/output interface 1502 is configured to obtain a first SSB: the logic circuit 1501 is configured to determine a random access preamble corresponding to the first SSB; and the input/output interface 1502 is further configured to send the random access preamble corresponding to the first SSB. The input/output interface 1502 further performs another step performed by the terminal device in any one of the foregoing embodiments, and implement corresponding beneficial effects. Details are not described herein again.

Optionally, the logic circuit 1501 is configured to determine a first SSB: the input/output interface 1502 is configured to send the first SSB; and the input/output interface 1502 is further configured to send a random access preamble corresponding to the first SSB. The input/output interface 1502 further performs another step performed by the network device in any one of the embodiments, and implement corresponding beneficial effects. Details are not described herein again.

In at least one embodiment, the processing unit 1401 shown in FIG. 14 is the logic circuit 1501 in FIG. 15.

Optionally, the logic circuit 1501 is a processing apparatus. Some or all functions of the processing apparatus is implemented by using software.

Optionally, the processing apparatus includes a memory and a processor. The memory is configured to store a computer program, and the processor reads and executes the computer program stored in the memory, to perform corresponding processing and/or steps in any one of the method embodiments.

Optionally, the processing apparatus includes only a processor. A memory configured to store a computer program is located outside the processing apparatus, and the processor is connected to the memory through a circuit/wire, to read and execute the computer program stored in the memory. The memory and the processor are integrated together, or is physically independent of each other.

Optionally, the processing apparatus is one or more chips, or one or more integrated circuits. For example, the processing apparatus is one or more field-programmable gate arrays (field-programmable gate arrays, FPGAs), application-specific integrated circuits (application-specific integrated circuits, ASICs), system on chips (system on chips, SoCs), central processing units (central processor units, CPUs), network processors (network processors, NPs), digital signal processing (digital signal processors, DSPs), micro controller units (micro controller units, MCU), programmable logic devices (programmable logic devices, PLDs), or other integrated chips, or any combination of the foregoing chips or processors.

FIG. 16 shows a communication apparatus 1600 related to the foregoing embodiment according to at least one embodiment. The communication apparatus 1600 is specifically the communication apparatus used as the terminal device in the foregoing embodiment. An example shown in FIG. 16 is that the terminal device is implemented through a terminal device (or a component in a terminal device).

In a schematic diagram of a logical structure of the communication apparatus 1600, the communication apparatus 1600 includes but is not limited to at least one processor 1601 and a communication port 1602.

Further, optionally, the apparatus includes a memory 1603 and/or a bus 1604. In at least one embodiment, the at least one processor 1601 is configured to control on an action of the communication apparatus 1600.

In addition, the processor 1601 is a central processing unit, a general-purpose processor, a digital signal processor, an application-specific integrated circuit, a field-programmable gate array or another programmable logic device, a transistor logic device, a hardware component, or any combination thereof. The processor implements or execute various example logical blocks, modules, and circuits described with reference to content disclosed in at least one embodiment. Alternatively, the processor is a combination of processors implementing a computing function, for example, a combination of one or more microprocessors, or a combination of a digital signal processor and a microprocessor. A person skilled in the art understands that, for the purpose of convenient and brief description, for detailed working processes of the foregoing system, apparatus, and unit, refer to corresponding processes in the foregoing method embodiments. Details are not described herein again.

The communication apparatus 1600 shown in FIG. 16 is specifically configured to implement steps implemented by the terminal device in the foregoing method embodiments, and implement technical effects corresponding to the terminal device. For a specific implementation of the communication apparatus shown in FIG. 16, refer to the descriptions in the foregoing method embodiments. Details are not described herein again.

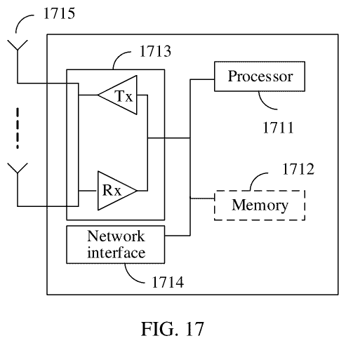

FIG. 17 is a schematic diagram of a structure of a communication apparatus 1700 related to the foregoing embodiment according to at least one embodiment. The communication apparatus 1700 is specifically the communication apparatus used as the network device in the foregoing embodiment. An example shown in FIG. 17 is that the network device is implemented through a network device (or a component in a network device). For the structure of the communication apparatus, refer to the structure shown in FIG. 17.

The communication apparatus 1700 includes at least one processor 1711 and at least one network interface 1714. Further, optionally, the communication apparatus further includes at least one memory 1712, at least one transceiver 1713, and one or more antennas 1715. The processor 1711, the memory 1712, the transceiver 1713, and the network interface 1714 are connected to each other, for example, through a bus. In at least one embodiment, the connection includes various types of interfaces, transmission lines, buses, or the like. This is not limited in this embodiment. The antenna 1715 is connected to the transceiver 1713. The network interface 1714 is configured to enable the communication apparatus to communicate with another communication device through a communication link. For example, the network interface 1714 includes a network interface between the communication apparatus and a core network device, for example, an SI interface. The network interface includes a network interface between the communication apparatus and another communication apparatus (for example, another network device or core network device), for example, an X2 or Xn interface.

The processor 1711 is mainly configured to: process a communication protocol and communication data: control the entire communication apparatus: execute a software program; and process data of the software program. For example, the processor 1711 is configured to support the communication apparatus in performing the actions in embodiments. The communication apparatus includes a baseband processor and a central processing unit. The baseband processor is mainly configured to process the communication protocol and the communication data. The central processing unit is mainly configured to control the entire terminal device, execute the software program, and process the data of the software program. Functions of the baseband processor and the central processing unit is integrated into the processor 1711 in FIG. 17. A person skilled in the art understands that the baseband processor and the central processing unit each is an independent processor, and are interconnected through a technology such as a bus. A person skilled in the art understands that the terminal device includes a plurality of baseband processors to adapt to different network standards, and the terminal device includes a plurality of central processing units to enhance processing capabilities of the terminal device, and components of the terminal device is connected through various buses. The baseband processor is also expressed as a baseband processing circuit or a baseband processing chip. The central processing unit is also expressed as a central processing circuit or a central processing chip. A function of processing the communication protocol and the communication data is built in the processor, or is stored in the memory in a form of a software program, and the processor executes the software program to implement a baseband processing function.

The memory is mainly configured to store the software program and data. The memory 1712 exists independently, and is connected to the processor 1711. Optionally, the memory 1712 is integrated with the processor 1711, for example, integrated into one chip. The memory 1712 stores program code for executing the technical solutions in at least one embodiment, and the processor 1711 controls the execution. Various types of executed computer program code are also considered as drivers of the processor 1711.

FIG. 17 shows only one memory and one processor. In an actual terminal device, there is a plurality of processors and a plurality of memories. The memory is also referred to as a storage medium, a storage device, or the like. The memory is a storage element on a same chip as the processor, that is, an on-chip storage element, or is an independent storage element. This is not limited in at least one embodiment.

The transceiver 1713 is configured to support receiving or sending of a radio frequency signal between the communication apparatus and a terminal, and the transceiver 1713 is connected to the antenna 1715. The transceiver 1713 includes a transmitter Tx and a receiver Rx. Specifically, the one or more antennas 1715 receives a radio frequency signal. The receiver Rx in the transceiver 1713 is configured to: receive the radio frequency signal from the antenna, convert the radio frequency signal into a digital baseband signal or a digital intermediate frequency signal, and provide the digital baseband signal or the digital intermediate frequency signal for the processor 1711, so that the processor 1711 performs further processing, for example, demodulation and decoding, on the digital baseband signal or the digital intermediate frequency signal. In addition, the transmitter Tx in the transceiver 1713 is further configured to: receive a modulated digital baseband signal or digital intermediate frequency signal from the processor 1711, convert the modulated digital baseband signal or digital intermediate frequency signal into a radio frequency signal, and send the radio frequency signal through the one or more antennas 1715. Specifically, the receiver Rx selectively performs one-level or multi-level down-conversion mixing and analog-to-digital conversion on the radio frequency signal, to obtain the digital baseband signal or the digital intermediate frequency signal. A sequence of the down-conversion mixing and the analog-to-digital conversion is adjustable. The transmitter Tx selectively performs one-level or multi-level up-conversion mixing processing and digital-to-analog conversion on the modulated digital baseband signal or digital intermediate frequency signal, to obtain the radio frequency signal. A sequence of the up-conversion mixing processing and the digital-to-analog conversion is adjustable. The digital baseband signal and the digital intermediate frequency signal is collectively referred to as a digital signal.

The transceiver 1713 is also referred to as a transceiver unit, a transceiver machine, a transceiver apparatus, or the like. Optionally, a component configured to implement a receiving function in the transceiver unit is considered as a receiving unit, and a component configured to implement a sending function in the transceiver unit is considered as a sending unit. In other words, the transceiver unit includes the receiving unit and the sending unit. The receiving unit is also referred to as a receiving machine, an input port, a receiving circuit, or the like. The sending unit is referred to as a transmitting machine, a transmitter, a transmitting circuit, or the like.

The communication apparatus 1700 shown in FIG. 17 is specifically configured to implement steps implemented by the network device in the foregoing method embodiments, and implement technical effects corresponding to the network device. For a specific implementation of the communication apparatus 1700 shown in FIG. 17, refer to the descriptions in the foregoing method embodiments. Details are not described herein again.

At least one embodiment further provides a computer-readable storage medium storing one or more computer-executable instructions. In response to the computer-executable instructions being executed by a processor, the processor performs the method in the implementations of the terminal device in the foregoing embodiments.

At least one embodiment further provides a computer-readable storage medium storing one or more computer-executable instructions. In response to the computer-executable instructions being executed by a processor, the processor performs the method in the implementations of the network device in the foregoing embodiments.

At least one embodiment further provides a computer program product (or referred to as a computer program) storing one or more computers. In response to the computer program product being executed by a processor, the processor performs the method in the implementations of the foregoing terminal device.

At least one embodiment further provides a computer program product storing one or more computers. In response to the computer program product being executed by a processor, the processor performs the method in the implementations of the foregoing network device.

At least one embodiment further provides a chip system. The chip system includes at least one processor, configured to support a communication apparatus in implementing functions in the foregoing implementations of the communication apparatus. Optionally, the chip system further includes an interface circuit, and the interface circuit provides program instructions and/or data for the at least one processor. In a possible design, the chip system further includes a memory.

The memory is configured to store program instructions and data that are used for the communication apparatus. The chip system includes a chip, or includes a chip and another discrete component. The communication apparatus is specifically the terminal device in the foregoing method embodiments.

At least one embodiment further provides a chip system. The chip system includes at least one processor, configured to support a communication apparatus in implementing functions in the foregoing implementations of the communication apparatus. Optionally, the chip system further includes an interface circuit, and the interface circuit provides program instructions and/or data for the at least one processor. In a possible design, the chip system further includes a memory. The memory is configured to store program instructions and data that are used for the communication apparatus. The chip system includes a chip, or includes a chip and another discrete component. The communication apparatus is specifically the network device in the foregoing method embodiments.

At least one embodiment further provides a communication system. The network system architecture includes the terminal device and the network device in any one of the foregoing embodiments.

In the several embodiments provided in at least one embodiment, the disclosed system, apparatus, and method are implemented in another manner. For example, the described apparatus embodiment is merely an example. For example, division into the units is merely logical function division and there is another division manner in actual implementation. For example, a plurality of units or components is combined or integrated into another system, or some features are ignored or not performed. In addition, the displayed or discussed mutual couplings or direct couplings or communication connections are implemented by using some interfaces. The indirect couplings or communication connections between the apparatuses or units are implemented in an electronic form, a mechanical form, or another form.

The units described as separate parts is or is not physically separate, and parts displayed as units is or is not physical units, is located in one position, or is distributed on a plurality of network units. Some or all of the units is selected according to actual usage to achieve the objectives of the solutions of embodiments.

In addition, functional units in at least one embodiment are integrated into one processing unit, each of the units exists alone physically, or two or more units are integrated into one unit. The integrated unit is implemented in a form of hardware, or is implemented in a form of a software functional unit. In response to the integrated unit being implemented in the form of the software functional unit and sold or used as an independent product, the integrated unit is stored in a computer-readable storage medium. Based on such an understanding, the technical solutions of at least one embodiment essentially, or the part contributing to the prior art, or all or some of the technical solutions is implemented in the form of a software product. The computer software product is stored in a storage medium and includes several instructions for enabling a computer device (which is a personal computer, a server, or a network device) to perform all or some of the steps of the methods described in at least one embodiment. The storage medium includes any medium that stores program code, such as a USB flash drive, a removable hard disk, a read-only memory (ROM, Read-Only Memory), a random access memory (RAM, Random Access Memory), a magnetic disk, or an optical disc.

1. A communication method for a terminal device, comprising:
obtaining, a first synchronization signal block (SSB); and
sending, a random access preamble corresponding to the first SSB, wherein the random access preamble is carried at a first time domain position, the first time domain position is associated with a timing offset value, and the timing offset value is determined based on a round-trip delay between a network device and a first position in an area covered by the network device.

2. The method according to claim 1, wherein
the first time domain position is obtained by offsetting a first moment based on the timing offset value, and the first moment is associated with the first SSB.

3. The method according to claim 2, wherein the offsetting the first moment includes offsetting the first by at least one of the following:
an end moment of a time domain position of the first SSB;
a start moment of a time domain position of the first SSB;
an end moment of a slot in which a time domain position of the first SSB is located: or
a start moment of a slot in which a time domain position of the first SSB is located.

4. The method according to claim 1, wherein the method further comprises:
obtaining, the timing offset value.

5. The method according to claim 1, wherein the sending, a random access preamble corresponding to the first SSB includes:
sending, based on first information, the random access preamble corresponding to the first SSB, wherein the first information includes at least one of the following;
a time length of the first time domain position;
a quantity of random access channel occasion (RO) resources included in the first time domain position, wherein the RO resource is usable to carry the random access preamble; or
a quantity of SSBs corresponding to the first time domain position.

6. The method according to claim 1, wherein
the sending the random access preamble corresponding to the first SSB carried at the first time domain position associated with the timing offset value includes sending the random access preamble corresponding to the first SSB carried at the first time domain position associated with the timing offset value and second information, and the second information includes at least one of the following;
n first preset values, wherein n is usable to indicate an index position of the first SSB in an SSB set, and n is a natural number;
processing delay information;
positioning error information; or
ephemeris error information.

7. The method according to claim 1, wherein
the sending the random access preamble corresponding to the first SSB carried at the first time domain position associated with the timing offset value includes sending the random access preamble corresponding to the first SSB carried at the first time domain position associated with the timing offset value having a value related to a value of an offset Koffset value, wherein the Koffset value is usable to determine a scheduling interval of a physical uplink shared channel (PUSCH) signal.

8. An apparatus, comprising:
at least one processor; and
a non-transitory computer-readable medium including computer-executable instructions that, when executed by the processor, cause the at least one processor to perform operations for:
obtaining, a first synchronization signal block (SSB); and
sending, a random access preamble corresponding to the first SSB, wherein the random access preamble is carried at a first time domain position, the first time domain position is associated with a timing offset value, and the timing offset value is determined based on a round-trip delay between a network device and a first position in an area covered by the network device.

9. The apparatus according to claim 8, wherein
the at least one processor is further configured to obtain the first time domain position by offsetting a first moment based on the timing offset value, and the first moment is associated with the first SSB.

10. The apparatus according to claim 9, wherein the first moment includes at least one of the following:
an end moment of a time domain position of the first SSB;
a start moment of a time domain position of the first SSB;
an end moment of a slot in which a time domain position of the first SSB is located: or
a start moment of a slot in which a time domain position of the first SSB is located.

11. The apparatus according to claim 8, wherein the at least one processor is further configured to:
obtain, the timing offset value.

12. The apparatus according to claim 8, wherein the at least one processor is further configured to send, a random access preamble corresponding to the first SSB by:
sending, based on first information, the random access preamble corresponding to the first SSB, wherein the first information includes at least one of the following;
a time length of the first time domain position;
a quantity of random access channel occasion (RO) resources included in the first time domain position, wherein the RO resource is usable to carry the random access preamble; or
a quantity of SSBs corresponding to the first time domain position.

13. The apparatus according to claim 8, wherein
the first time domain position is associated with the timing offset value and second information, and the second information includes at least one of the following;
n first preset values, wherein n is usable to indicate an index position of the first SSB in an SSB set, and n is a natural number;
processing delay information;
positioning error information: or
ephemeris error information.

14. The apparatus according to claim 8, wherein
a value of the timing offset value is related to a value of an offset Koffset value, wherein the Koffset value is usable to determine a scheduling interval of a physical uplink shared channel (PUSCH) signal.

15. An apparatus, comprising:
at least one processor; and
a non-transitory computer-readable medium including computer-executable instructions that, when executed by the processor, cause the processor to perform operations for:
sending, a first synchronization signal block (SSB); and
obtaining, a random access preamble corresponding to the first SSB, wherein the random access preamble is carried at a first time domain position, the first time domain position is associated with a timing offset value, and the timing offset value is determined based on a round-trip delay between the network device and a first position in an area covered by the network device.

16. The apparatus according to claim 15, wherein the at least one processor is further configured to obtain the first time domain position by offsetting a first moment based on the timing offset value, and the first moment is associated with the first SSB.

17. The apparatus according to claim 16, wherein the first moment includes at least one of the following:
an end moment of a time domain position of the first SSB;
a start moment of a time domain position of the first SSB;
an end moment of a slot in which a time domain position of the first SSB is located: or
a start moment of a slot in which a time domain position of the first SSB is located.

18. The apparatus according to claim 15, wherein the at least one processor is further configured to obtain the random access preamble corresponding to the first SSB by:
obtaining, based on first information, the random access preamble corresponding to the first SSB, wherein the first information is usable to indicate at least one of the following;
a time length of the first time domain position;
a quantity of random access channel occasion (RO) resources included in the first time domain position, wherein the RO resource is usable to carry the random access preamble; or
a quantity of SSBs corresponding to the first time domain position.

19. The apparatus according to claim 15, wherein
the first time domain position is associated with the timing offset value and second information, and the second information includes at least one of the following;
n first preset values, wherein n is usable to indicate an index position of the first SSB in an SSB set, and n is a natural number;
processing delay information;
positioning error information: or
ephemeris error information.

20. The apparatus according to claim 15, wherein
a value of the timing offset value is related to a value of an offset Koffset value, wherein the Koffset value is usable to determine a scheduling interval of a physical uplink shared channel (PUSCH) signal.
